(19) United States
(12) Patent Application Publication
(10) Pub. No.: US 2026/0067538 A1
(43) Pub. Date: Mar. 5, 2026

(54) INFORMATION PROCESSING SYSTEM, INFORMATION PROCESSING APPARATUS, AND CONTENT PLAYBACK APPARATUS

(71) Applicant: SONY GROUP CORPORATION, TOKYO (JP)

(72) Inventors: HIROAKI ADACHI, TOKYO (JP); TAKASHI KINOSHITA, Tokyo (JP)

(21) Appl. No.: 18/247,838

(22) PCT Filed: Oct. 4, 2021
(86) PCT No.: PCT/JP2021/036598

§ 371 Date: Jun. 10, 2025

(30) Foreign Application Priority Data
Oct. 15, 2020 (JP) 2020-174272

(51) Int. Cl. H04N 21/472; H04N 21/439

(52) U.S. Cl. CPC H04N 21/47217; H04N 21/4394

(57) ABSTRACT

An information processing system according to an embodiment of the present technology includes an acquisition unit, a setting unit, and a playback control unit. The acquisition unit acquires map information. The setting unit associates a region, playback target content, and type information with each other and sets the region, the playback target content, and the type information as content region information, the region being set on the basis of the map information, the type information indicating a playback control type for the playback target content. The playback control unit controls playback of the playback target content on the basis of the type information. In this information processing system, the region, the playback target content, and the type information indicating the playback control type are associated with each other and set as the content region information. This can provide a new user experience.

### TECHNICAL FIELD

The present technology relates to an information processing system, an information processing apparatus, and a content playback apparatus that can be applied to production of content using position information.

### BACKGROUND ART

Patent Literature 1 has disclosed a display method. The display method includes grouping content information and displaying a content information list. The display method includes grouping many pieces of content located in a certain area on a map into a suitable number of pieces of content. The display method also includes displaying a representative marker of the group on the map. Selecting the representative marker displays detailed information of a piece of content belonging in the group. This can easily select content arranged on the map (specification paragraphs [0001], [0007] to [0009], FIG. 3, etc. in Patent Literature 1).

### CITATION LIST

### Patent Literature

Patent Literature 1: Japanese Patent Application Laid-open No. 2010-257044

### DISCLOSURE OF INVENTION

### Technical Problem

Content using position information will be popular in the future. It is thus desirable to provide a technology capable of providing a user with a new user experience (UX).

In view of the above-mentioned circumstances, it is an object of the present technology to provide an information processing system, an information processing apparatus, and a content playback apparatus that can provide a new user experience.

### Solution to Problem

In order to accomplish the above-mentioned object, an information processing system according to an embodiment of the present technology includes an acquisition unit, a setting unit, and a playback control unit.

The acquisition unit acquires map information.

The setting unit associates a region, playback target content, and type information with each other and sets the region, the playback target content, and the type information as content region information, the region being set on the basis of the map information, the type information indicating a playback control type for the playback target content.

The playback control unit controls playback of the playback target content on the basis of the type information.

In this information processing system, the region, the playback target content, and the type information indicating the playback control type are associated with each other and set as the content region information. This can provide a new user experience.

The playback control unit may control playback of the playback target content on the basis of a position of a viewer with respect to the region.

The playback control unit may control playback of the playback target content in accordance with entrance or exit of the viewer in/from the region.

The type information may define playback control on the playback target content in overlap regions overlapping each other, the playback target content being respectively included in a plurality of pieces of content region information with the regions overlapping each other.

The type information may define a degree of priority regarding playback control on the playback target content.

The type information may define a degree of priority regarding at least one of control on a predetermined parameter, play/non-play, or switching of playback contents.

The playback target content may include at least one of audio data or image data.

The type information may include first type information and second type information, the second type information having a degree of priority lower than a degree of priority of the first type information. In this case, the playback control unit may, in the overlap regions, play the playback target content associated with the first type information by a first control method, and play the playback target content associated with the second type information by a second control method different from the first control method in a case where the playback target content associated with the first type information is being played or play the playback target content associated with the second type information by a third control method different from the second control method in a case where the playback target content associated with the first type information is not being played.

The third control method may be a same control method as the first control method.

The type information may include first type information and second type information having a degree of priority lower than a degree of priority of the first type information. In this case, the playback control unit may restrict, in the overlap regions, playback of the playback target content associated with the second type information while the playback target content associated with the first type information is being played.

The type information may include first type information and second type information having a degree of priority lower than a degree of priority of the first type information. In this case, the playback control unit may switch, in the overlap regions, the playback contents with respect to the playback target content associated with the second type information in accordance with switching of play/non-play of the playback target content associated with the first type information.

The setting unit may associate the type information with the playback target content in accordance with a type of the playback target content.

The playback target content may be audio data. In this case, a type of the audio data may include at least one of speech, background music (BGM), or an ambient sound.

The setting unit may associate the speech with the type information with a first degree of priority, associate the BGM with the type information with a second degree of priority different from the first degree of priority, and associate the ambient sound with the type information with a third degree of priority different from each of the first degree of priority and the second degree of priority.

The setting unit may associate at least one of a region designated by a user or a region other than the region designated by the user with the playback target content and the type information and sets the content region information.

The information processing system may further include an output unit that outputs assistance information related to designation of the region by the user.

The assistance information may include at least one of image information including the map information, a graphical user interface (GUI), an icon, or an audio guide.

The information processing system may further include a display control unit that superimposes and displays the region on the map information.

An information processing apparatus according to an embodiment of the present technology includes an acquisition unit and a setting unit.

The acquisition unit acquires map information.

The setting unit associates a region, playback target content, and type information with each other and sets the region, the playback target content, and the type information as content region information, the region being set on the basis of the map information, the type information indicating a playback control type for the playback target content.

A content playback apparatus according to an embodiment of the present technology is a content playback apparatus that is connected to the information processing system and plays the playback target content in accordance with playback control by the information processing system.

### BRIEF DESCRIPTION OF DRAWINGS

FIG. 1 A schematic view showing a configuration example of a content providing system according to an embodiment of the present technology.

FIG. 2 A schematic view for describing a sound content map.

FIG. 3 A schematic view for describing type information.

FIG. 4 A schematic view showing an example of sound volume control depending on a degree of priority.

FIG. 5 A schematic view showing an example of controlling play/non-play depending on a degree of priority.

FIG. 6 schematic view showing an example of controlling switching of playback contents depending on a degree of priority.

FIG. 7 block diagram showing functional configuration examples of a content providing system in a first embodiment.

FIG. 8 schematic view showing an example of a GUI for settings in the first embodiment.

FIG. 9 schematic view for describing type information and a degree of priority in the first embodiment.

FIG. 10 schematic view showing an example of sound volume control based on the degree of priority.

FIG. 11 schematic view showing an example of the sound volume control based on the degree of priority.

FIG. 12 flowchart showing a processing example related to settings of a region and type information.

FIG. 13 flowchart showing a processing example related to settings of sound content data.

FIG. 14 schematic view for describing a tour sound.

FIG. 15 block diagram showing functional configuration examples of a content providing system in a second embodiment.

FIG. 16 schematic view showing an example of GUI for settings in the second embodiment.

FIG. 17 schematic view showing an example of the GUI for settings in the second embodiment.

FIG. 18 schematic view showing an example of sound volume control based on a degree of priority.

FIG. 19 schematic view showing an example of sound volume control based on the degree of priority.

FIG. 20 flowchart showing a processing example related to settings of a tour sound and sound content data.

FIG. 21 block diagram showing hardware configuration examples of a computer that can realize a viewer terminal, a content providing server, and an information processing apparatus.

### MODE(S) FOR CARRYING OUT THE INVENTION

Hereinafter, embodiments according to the present technology will be described with reference to the drawings.

### [Content Providing System]

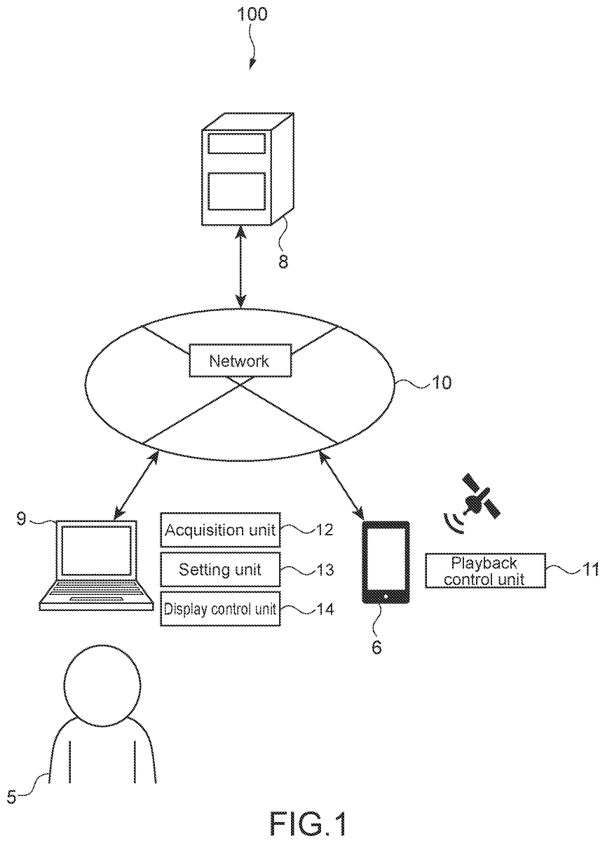

FIG. 1 is a schematic view showing a configuration example of a content providing system according to an embodiment of the present technology. A content providing system 100 functions as an embodiment of an information processing system according to the present technology.

In the present embodiment, the content providing system 100 can produce content using position information and provide the content to a content user.

Hereinafter, a sound content map is exemplified as the content using the position information. The sound content map plays speech such as words and narration, BGM, an ambient sound and/or the like when a content user wearing an acoustic treatment device such as headphones and earbuds enters a predetermined region. As a matter of course, the present technology has applications other than production of such a sound content map.

### [Sound Content Map]

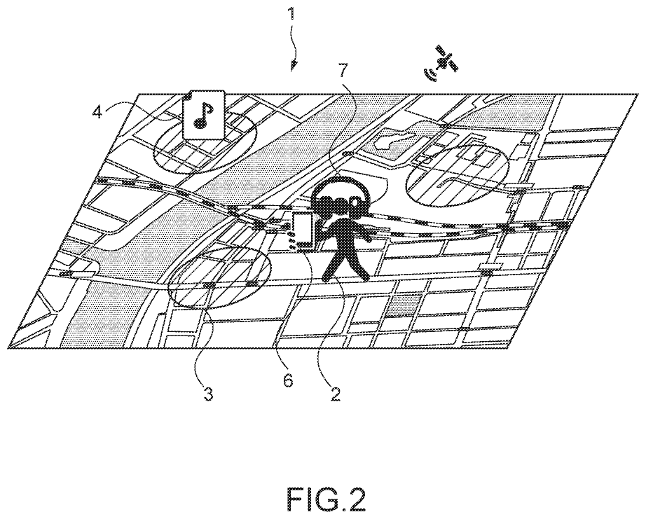

FIG. 2 is a schematic view for describing a sound content map 1.

The sound content map 1 is content using an audio AR system. The audio AR system can provide a content user 2 with an auditory augmented reality (AR) experience.

As shown in FIG. 2, predetermined regions 3 in the real world have sound content data 4 virtually arranged as playback target content. The sound content data 4 may include any audio data, e.g., speech such as words and narration, BGM, or an ambient sound.

A single region 3 may have a plurality of pieces of sound content data 4. Specifically, the single region 3 may have playback target content including the plurality of pieces of sound content data 4.

The playback target content to be played to the content user 2 may be non-sound content such as an AR object and an advertisement object other than the sound content data 4. In that case, for example, a content map replaces the sound content map. Moreover, the sound content data 4 may be combined with the non-sound content data.

The content user 2 can listen to the sound content data 4 arranged in the region 3 when entering the region 3 in the real world.

For example, the content user 2 walking in the Ryogoku-city can experience virtual content. For example, the content user 2 can hear narration describing a sumo history or a loud sumo stadium crowd cheering sound right after entering the Ryogoku Kokugikan.

Realizing the sound content map needs production of the content and playback of the sound content data 4.

A creator (content creator) 5 produces content. The creator 5 sets a region 3 on the basis of map information as specific examples. For example, latitude information and longitude information define position information the set region 3. For example, latitude information and longitude information of a circumferential portion, a vertex, a center position, or the like of the region 3 define the region 3. As a matter of course, the present technology is not limited to the use of such data.

The creator 5 associates a region 3 with sound content data 4 by arranging the sound content data 4 in the region 3. Specifically, the latitude information and longitude information of the region 3 and the sound content data 4 are stored in association with each other.

In addition, the creator 5 associates the sound content data 4 with type information indicating a playback control type. Thus, the region 3, the sound content data 4, and the type information are associated with each other. The type information will be described later.

In the present disclosure, information with the region 3, the sound content data 4, and the type information associated with each other is content region information. That is, the creator 5 sets the content region information.

The creator 5 corresponds to an embodiment of a user according to the present technology.

Moreover, the content user 2 corresponds to an embodiment of a viewer according to the present technology.

Moreover, the sound content data 4 corresponds to an embodiment of playback target content, audio data, and content data according to the present technology.

A viewer terminal 6 and headphones 7 play the sound content data 4 as shown in FIG. 2. The viewer terminal 6 is held by the content user 2. The headphones 7 are put on the content user 2

The viewer terminal may be any device. For example, the user terminal owned by the content user 2, such as a smartphone and a tablet terminal, installs an application (application program) according to the present technology for experiencing the sound content map 1. This can use the user terminal as the viewer terminal 6 for experiencing the sound content map 1.

Alternatively, the content user 2 may borrow a dedicated device for experiencing the sound content map 1 as the viewer terminal 6.

The audio output device may be any device other than the headphones 7, e.g., earbuds or a head-mounted display.

The viewer terminal 6 detects entrance and exit of the content user 2 in/from the region 3, for example. Calculating a position of the content user 2 with respect to the region 3 detects entrance or exit of the content user 2.

In the present embodiment, the viewer terminal 6 is a device equipped with a position sensor for acquiring position information. In the present embodiment, the position sensor is a GPS sensor as an example. The GPS sensor can acquire position information (latitude information and longitude information) by receiving a GPS signal from a GPS satellite. As a matter of course, the present technology is not limited thereto, and any other position sensor may be employed.

Position information (latitude information and longitude information) of the content user 2 with respect to the region 3 is calculated on the basis of the received GPS signal. Comparing the position information of the content user 2 with the position information of the region 3 detects entrance or exit.

For example, the content user 2 entering the region 3 starts the playback of the sound content data 4. Moreover, the content user 2 exiting the region 3 stops the playback of the sound content data 4. Moreover, a plurality of pieces of sound content data 4 is synthesized and the resulting synthetic data is played.

Specifically, detecting that the content user 2 enters the region 3 starts playback processing of the sound content data 4 associated with the region 3. Accordingly, the headphones 7 output a sound associated with the sound content data 4. Also, detecting that the content user 2 is located in the region 3 when the application according to the present embodiment is activated starts playback processing of the sound content data 4.

Detecting that the content user 2 exits the region 3 starts processing of stopping the playback of the sound content data 4 associated with the region 3. For example, in a case where the sound content data 4 is BGM, the playback of the BGM is stopped or the BGM fades out. In a case where the sound content data 4 is words or narration, the playback continues until words or the like ends and the playback is stopped when words or the like ends.

Moreover, for example, in a case where a plurality of regions 3 overlaps, synthesizing a plurality of pieces of sound content data 4 respectively associated with the regions 3 generates synthetic data. Then, the synthetic data is played in the overlap regions overlapping each other.

Any control other than the playback, playback stop, and synthesis of the sound content data 4 may be made.

The sound content map 1 can provide the content user 2 with a new high-quality virtual experience.

As shown in FIG. 1, the content providing system 100 includes the viewer terminal 6, a content providing server 8, and an information processing apparatus 9.

The viewer terminal 6, the content providing server 8, and the information processing apparatus 9 are connected to be capable of communicating with each other via a network 10.

For example, the Internet or a wide area communication network configures the network 10. In addition, any wide area network (WAN), any local area network (LAN), or the like may be used and a protocol for configuring the network 1 is not limited.

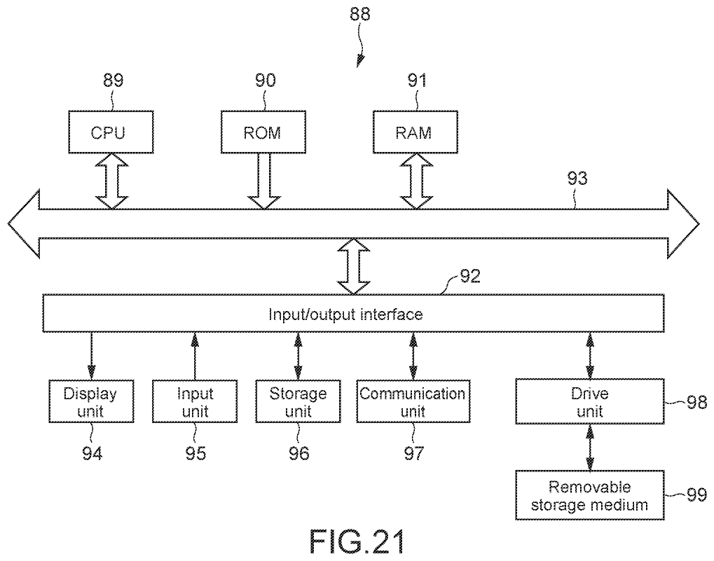

The viewer terminal 6, the content providing server 8, and the information processing apparatus 9 each have hardware required for a computer configuration, for example, a processor such as a CPU, a GPU, and a DSP, a memory such as a ROM and a RAM, and a storage device such as an HDD. As a matter of course, hardware such as an FPGA and an ASIC may be used (see FIG. 21).

For example, the processor loads the program according to the present technology prestored in the ROM or the like to the RAM and executes the program in order for each device to execute an information processing method according to the present technology.

Each device installs the program via various storage media, for example. Alternatively, each device may install the program via the Internet or the like.

The type and the like of the storage medium for storing the program are not limited, and any computer-readable storage medium may be used. For example, a computer-readable non-transitory arbitrary storage medium may be used.

For example, any computer such as a PC and a smartphone can realize each device. As a matter of course, the present technology is not limited to the case where the viewer terminal 6, the content providing server 8, and the information processing apparatus 9 have the same configuration.

The viewer terminal 6 may be any device equipped with a position sensor for acquiring position information. In the present embodiment, a device equipped with a GPS sensor is used. The GPS sensor acquires latitude information and longitude information of the viewer terminal 6 as the position information.

The viewer terminal 6 has a playback control unit 11 as a functional block. For example, the processor executes a predetermined program such as an application program in order to realize the playback control unit 11 as a software block. As a matter of course, dedicated hardware such as an integrated circuit (IC) may be used for realizing each block.

The playback control unit 11 controls the playback of the sound content data 4 on the basis of a position of the content user 2 with respect to the region 3. Specifically, the playback control unit 11 controls the playback of the sound content data 4 in accordance with entrance or exit of the content in/from the region 3.

For example, as described above, the content user 2 entering the region 3 starts the playback of the sound content data. Moreover, the content user 2 exiting the region 3 stops the playback of the sound content data 4. In addition, synthesis and the like of the sound content data 4 are performed.

Moreover, the playback control unit 11 controls playback of the playback target content associated with the type information on the basis of the type information set as the content region information as described later in detail.

The creator 5 uses the information processing apparatus 9 for setting the content region information. That is, the creator 5 uses the information processing apparatus 9 as a creator tool.

The creator 5 can create a desired sound content map 1 by using the information processing apparatus 9. The created sound content map 1 is sent to the content providing server 8 as content to be provided to the viewer.

As shown in FIG. 1, the information processing apparatus 9 includes an acquisition unit 12, a setting unit 13, and a display control unit 14 as functional blocks.

For example, the processor executes a predetermined program in order to realize the acquisition unit 12, the setting unit 13, and the display control unit 14 as software blocks. As a matter of course, dedicated hardware such as an integrated circuit (IC) may be used for realizing each block.

The acquisition unit 12 acquires map information.

For example, the acquisition unit 12 acquires map information of various areas from a map server or the like connected to the network 10. As a matter of course, the present technology is not limited thereto, and the acquisition unit 12 may acquire map information via a storage medium or the like.

The map information associates latitude information and longitude information as position information of each point.

The information processing apparatus 9 can display the acquired map information on a display, for example. Moreover, the information processing apparatus 9 can acquire position information (latitude information and longitude information) of a point designated by the creator 5 or the like on the map information.

A panoramic image shot panoramically at each point in the real world may be displayed as the map information. For example, a panoramic image or the like shot from Hyakutan dori street may be displayed as the map information. Alternatively, an aerial photograph, a satellite photograph, or the like may be displayed as the map information.

For example, downloading software for using the map information from the map server or the like may enable display and scale change of the map information, acquisition of position information of each point depending on the scale, and the like. Alternatively, in a case where an application programming interface (API) for using the map information is open to the public, calling the API may enable use of the map information.

It should be noted that the viewer terminal 6 and the content providing server 8 can also acquire and use the map information.

The setting unit 13 associates the regions 3 set on the basis of the map information, the sound content data 4, and the type information indicating the playback control type for the sound content data 4 with each other and sets them as the content region information.

The display control unit 14 superimposes and displays the regions 3 on the map information. Moreover, the display control unit 14 controls the display of a graphical user interface (GUI) for settings to be described later.

In the present embodiment, the display of the regions 3 superimposed on the map information, the display of the GUI for settings, and the like are included in output of assistance information related to designation of the region 3.

It should be noted that the assistance information includes any information for assisting the designation task of the region 3 by the creator 5. For example, the assistance information includes any information for assisting the designation of the region 3. This information includes any image information such as a GUI, an icon, and a guide, any audio information such as an audio guide, and the like.

Moreover, outputting the assistance information includes any data output method that can present the assistance information to the creator 5. This data output method includes display of an image such as a GUI, audio output of an audio guide, and the like.

As a matter of course, outputting the image information (assistance information) on the display device for displaying the image information (assistance information) through the display device is also included in the output of the assistance information. Moreover, outputting the assistance information to a loudspeaker or the like for outputting the audio information (assistance information) through the loudspeaker or the like is also included in the output of the assistance information.

For example, an output unit (not shown) realized as a software block outputs the assistance information. The display control unit 14 shown in FIG. 1 can also function as the output unit.

The content providing server 8 receives and manages the sound content map 1 created by the creator 5 using the information processing apparatus 9. Then, the content providing server 8 delivers an application for experiencing the sound content map 1 to the viewer terminal 6.

The viewer terminal 6 sends a request to deliver the application program via the network 10, for example. Delivery allowance from the content providing server 8 enables downloading the application program via the network 10.

Moreover, the content providing server 8 stores various types of information about this content providing system 100.

For example, the content providing server 8 may store the map information, the content region information, and the like. Moreover, the content providing server 8 may store various types of information, history information, and the like generated in past.

Such information is sent and received from/to the information processing apparatus 9 via the network 10 depending on needs.

### [Type Information]

The type information is information indicating the playback control type for the sound content data 4. That is, the type information defines how to play the sound content data 4 associated with each region 3.

When playing the sound content data 4, the playback is controlled depending on the type information associated with the sound content data 4. For example, sound volume control, whether or not to play the content, switching of the playback contents, or the like is performed in accordance with the type information. Any other control may be performed as the playback control type for the sound content data.

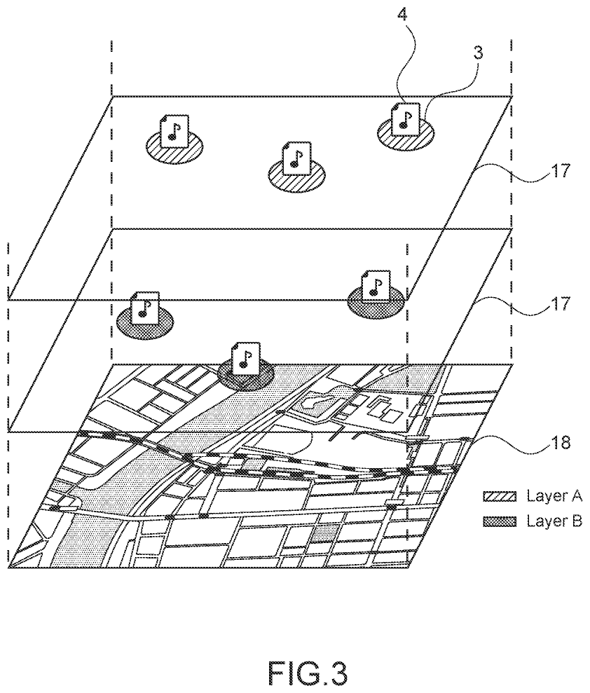

FIG. 3 is a schematic view for describing the type information.

In the present embodiment, the type information realizes a layered configuration of the content region information. The playback of the sound content data 4 is controlled in accordance with each layer. In the present embodiment, information identifying each layer (information indicating each layer) is associated with the regions 3 and the sound content data 4 as the type information.

Hereinafter, the type information will be called by a layer name, “layer A” or “layer B”, in some cases. That is, the phrase, “to associate the regions 3 with the layer A” will be used in some cases. Moreover, the regions 3 and the sound content data 4 associated with the layer A will be referred to as the regions 3 and the sound content data 4 of the layer A in some cases.

FIG. 3 shows two layers, the layers A and B. Regions each showing the layer A or B represent regions associated with map information 18 shown at the bottom.

The layer A is associated with three sets of (the regions 3 and the sound content data 4). That is, three pieces of content region information each constituted by (the regions 3, the sound content data 4, and the layer A) are set in the example shown in FIG. 3.

The layer B is associated with three sets of (the regions 3 and the sound content data 4). That is, three pieces of content region information each constituted by (the regions 3, the sound content data 4, and the layer B) are set in the example shown in FIG. 3.

That is, a total of six pieces of content region information, three in the layer A and three in the layer B, are set in the example shown in FIG. 3.

Associating the regions 3 and the sound content data 4 with the type information indicating the playback control type in this manner can realize the layered configuration of the content region information as to the playback control. As a matter of course, the present technology has applications other than making the layered configuration as illustrated in FIG. 3. Moreover, as a matter of course, the playback control using the type information according to the present technology does not represent only the layered configuration as illustrated in FIG. 3.

For example, associating the type information can also be said to be grouping for each playback control type. In this case, playback control for each group plays the sound content data 4.

Regions 3 associated with different layers may overlap each other. For example, the regions 3 associated with the layer A and the regions 3 associated with the layer B may be arranged overlapping each other on the map.

In this case, the regions 3 associated with the layer A and the regions 3 associated with the layer B have overlap regions overlapping each other.

A plurality of pieces of sound content data 4 as playback targets is provided to the content user 2 entering the overlap regions. For example, the content user 2 enters the overlap regions of a region A associated with the layer A and sound content data A and a region B associated with the layer B and sound content data B. In this case, the content user 2 is located both in the region A and the region B. Thus, both the sound content data A and the sound content data B are playback targets for the content user 2.

In such a case, for example, synthetic data synthesizing (mixing) the sound content data A and the sound content data B is played to the content user 2. For example, the sound volume, tone, and localization of the respective pieces of sound content data 4 are adjusted and reflected on an auditory sensation of the synthetic data.

The present embodiment performs playback control on the respective pieces of sound content data 4 in the overlap regions on the basis of the type information. That is, the type information defines playback control on the sound content data 4 in the overlap region, the sound content data 4 being included in each of the plurality of pieces of content region information whose regions 3 overlap each other.

Specifically, various parameters in mixing the respective pieces of sound content data 4 are controlled on the basis of the type information such as the layer A and the layer B. Any parameters such as sound volume, sound quality, localization, and effect may be set as various parameters.

Mixing the respective pieces of sound content data 4 on the basis of the set parameters generates synthetic data. That is, an auditory sensation of the synthetic data is determined on the basis of the type information such as the layer A and the layer B.

The generated synthetic data is played to the content user 2. Synthesis of a plurality of pieces of sound content data 4 is an example of the playback control using the type information. Any playback control such as control of play/non-play and switching of the playback contents may be performed as the playback control using the type information.

### [Degree of Priority]

The type information may define a degree of priority regarding playback control on the sound content data 4. That is, each layer may define the degree of priority regarding the playback control on the sound content data 4.

For example, the type information can define a degree of priority regarding control on predetermined parameters such as sound volume, sound quality, localization, and effect, play/non-play, switching of the playback contents, or the like.

The degree of priority is set on the basis of, for example, whether or not it is a sound to which the content user 2 should preferentially listen, whether or not it is a sound to which the content user 2 will wish to preferentially listen, or the like. The type information is set to apply a higher degree of priority to a sound to which the content user 2 should preferentially listen or a sound to which the content user 2 will wish to preferentially listen. As a matter of course, the present technology is not limited to such setting of the degree of priority.

The sound with the higher degree of priority is subjected to processing of increasing the sound volume preferentially, for example, when playing the sound content data 4.

For example, a degree of priority of narration including information important to the content user 2 is set to be higher. This realizes playback control on the narration so that the content user 2 can easily hear it. As a result, the content user 2 can easily recognize the important information. This can provide a high-quality user experience. As a matter of course, the present technology is not limited to such processing.

The degree of priority may be defined with respect to playback control on image data. A higher degree of priority is set to, for example, an image that the content user 2 should visually recognize or an image that the content user 2 will wish to visually recognize.

The image with the higher degree of priority is subjected to processing of increasing the image quality preferentially or increasing the image size preferentially, for example. As a matter of course, the present technology is not limited to such processing.

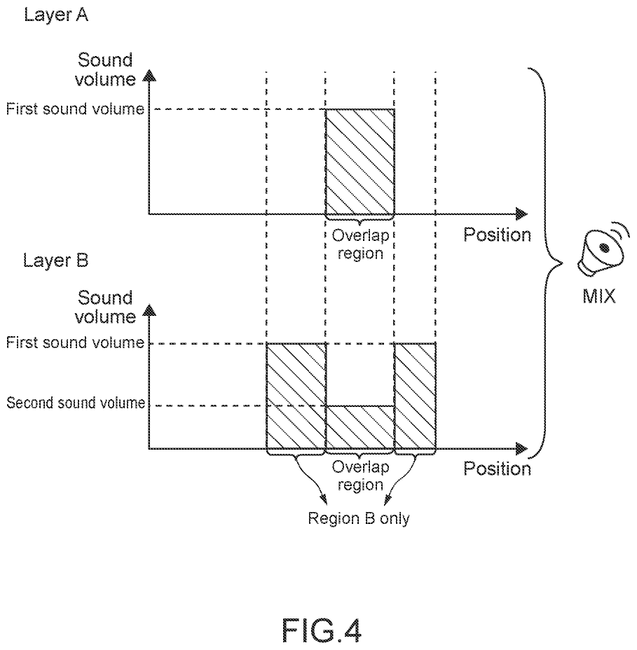

An example of playback control depending on a degree of priority will be described with reference to FIGS. 4 to 6.

For example, in the example shown in FIG. 3, the layer A has a higher degree of priority than the layer B. In this case, the layer A corresponds to first type information. Moreover, the layer B corresponds to second type information with a degree of priority than a degree of priority of the first type information.

In the present embodiment, the playback control unit 11 plays, in the overlap region, the sound content data A associated with the layer A by a first control method. Moreover, regarding the sound content data B associated with the layer B, the playback control unit 11 plays it by a second control method different from the first control method in a case where the sound content data A is being played or plays it by a third control method different from the second control method in a case where the sound content data A is not being played. It should be noted that the third control method may be the same control method as the first control method.

The playback control unit 11 performs, for example, sound volume control, playback restriction, or switching of the playback contents as the control method. Hereinafter, the three control methods will be described.

It should be noted that for example, in a case where the content data is image data, image quality change, image size change, or the like is performed as the control method. In addition, the control method of the content data is not limited.

FIG. 4 is a schematic view showing an example of sound volume control depending on a degree of priority.

FIG. 4 shows a sound volume depending on the position of the content user 2 when playing each of the sound content data A of the layer A and the sound content data B of the layer B.

In both the graphs of the layer A and the layer B in FIG. 4, the horizontal axis indicates the position of the content user 2 and the vertical axis indicates the sound volume of the sound content data.

In the example shown in FIG. 4, the region B of the layer B includes the region A of the layer A. Thus, the entire region A is an overlap region where the region A and the region B overlap each other

Only the sound content data B is played at a first sound volume in regions where only the region B of the layer B is arranged, regions of the region B, which exclude the overlap region, as shown in FIG. 4.

The creator 5 sets the first sound volume to be a desired level. For example, the creator 5 sets the first sound volume so that the content user 2 can easily hear the sound, considering device characteristics and the like of the headphones 7 that outputs the sound. Otherwise, a method of setting the first sound volume is not limited.

The sound content data A is played at the first sound volume in the overlap region where the region A of the layer A and the region B of the layer B overlap each other. On the other hand, the sound content data B is played at a second sound volume lower than the first sound volume.

As to a method of setting the second sound volume lower than the first sound volume, the second sound volume is set not to interfere with playback of the sound content data A with the higher degree of priority, for example. As a matter of course, the present technology is not limited thereto.

In this manner, in the overlap region, the playback control unit 11 plays the sound content data A associated with the layer A at the first sound volume and plays the sound content data B associated with the layer B at the second sound volume lower than the first sound volume in a case where the sound content data A associated with the layer A is being played.

Specifically, synthetic data with an auditory sensation is played so that the content user 2 can hear the sound content data A at the first sound volume and the sound content data B at the second sound volume in the overlap region. It should be noted that the respective pieces of sound content data 4 may be played individually at the first sound volume and the second sound volume without synthesizing the sound content data 4.

Controlling the sound volume of each piece of sound content data in the overlap region as appropriate on the basis of the degree of priority can play the sound content data A with the higher degree of priority so that the content user 2 can easily hear it while playing the other sound content data B overlapping it. This can provide a new user experience.

For example, the content user 2 moving in the regions 3 where only the region B is arranged plays only the sound content data B. The content user 2 entering the overlap region in this state can provide such an auditory sensation that playback of the sound content data A newly starts and the sound volume of the originally played sound content data B is reduced right after entering.

Furthermore, the content user 2 exiting the overlap region in this state and moving in the region where only the region B is arranged again can provide such an auditory sensation that the playback of the sound content data A stops and the original sound volume of the sound content data B is output right after exiting.

Moreover, for example, the content user 2 entering the overlap region from the region where only the region B is arranged gradually increases the sound volume of the sound content data A to be the first sound volume finally (fade-in). Moreover, the content user 2 exiting the overlap region and entering the region where only the region B is arranged again gradually reduce the sound volume of the sound content data A (fade-out) and gradually increases the sound volume of the sound content data B (fade-in). This enables the content user 2 to clearly experience entrance/exit between the regions with a sense of presence.

In this manner, in the overlap region, the sound content data A with the higher degree of priority is played at a higher sound volume than the sound content data B with the lower degree of priority.

For example, in a case where the sound content data A has a higher degree of importance than the sound content data B, setting of the degree of priority and playback control are performed as in the present embodiment. If the sound content data B is played at the higher sound volume in the overlap region, the content user 2 may not be able to easily hear the sound content data A including important information. Thus, setting the degree of priority of the layer A to be higher reduces the sound volume of the sound content data B in a case where the sound content data A is played. This enables the content user 2 to easily hear the sound content data A.

It is assumed that the duration (playback time) of the sound content data A is determined. For example, the sound content data A is narration for three minutes. In this case, in a case where the playback of the sound content data A ends while the content user 2 is located in the overlap region, the sound volume of the content data B may be set to be the first sound volume. That is, in a case where the sound content data A is not being played, the sound content data B may be played at the higher sound volume even in the overlap region.

On the other hand, in a case where the playback of the sound content data A is not finished while the content user 2 is located only in the region B after exiting the overlap region, the sound content data A may be played at the first sound volume and the sound content data B may be played at the second sound volume.

That is, the sound content data A may be played at the higher sound volume and the sound content data B may be played at the lower sound volume in a case where the playback of the sound content data A continues even after the content user 2 exits the overlap region.

It should be noted that any settings are possible with respect to the playback sound volume of the sound content data B in a region other than the overlap region and the playback sound volume of each of the sound content data A and the sound content data B in the overlap region.

For example, the playback sound volume of the sound content data A in the overlap region may be higher than the playback sound volume of the sound content data B in the region other than the overlap region. Otherwise, any sound volume control may be based on the degree of priority for realizing content with an enhanced sense of presence to the user.

The sound content data A corresponds to an embodiment of the playback target content associated with the first type information according to the present technology. Moreover, the sound content data B corresponds to an embodiment of the playback target content associated with the second type information according to the present technology.

Moreover, in the present embodiment, as to the sound volume control on the sound content data 4, playback at the first sound volume is performed as the first control method and the third control method. Playback at the second sound volume is performed as the second control method. That is, in the present embodiment, the same control method is used as the first control method and the third control method.

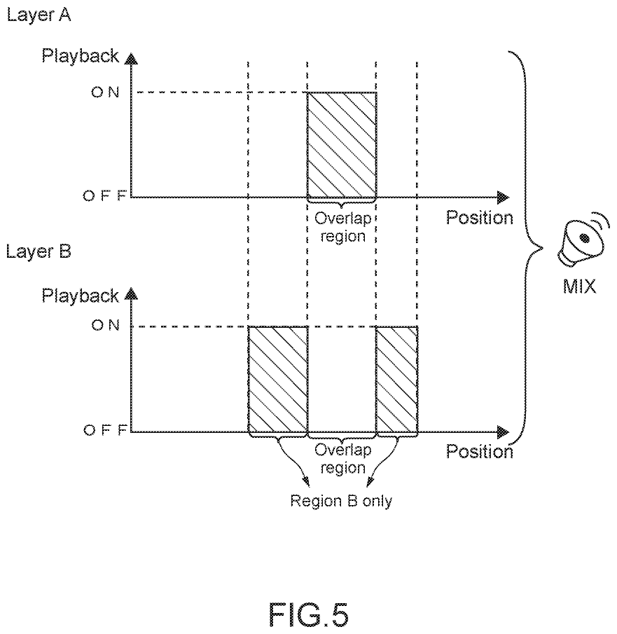

FIG. 5 is a schematic view showing an example of controlling play/non-play depending on a degree of priority.

FIG. 5 shows play/non-play (ON/OFF) depending on the position of the content user 2 when playing each of the sound content data A of the layer A and the sound content data B of the layer B.

In the example shown in FIG. 5, the playback of the sound content data B with the lower degree of priority is stopped in the overlap region.

The playback control unit 11 restricts, in the overlap region, the playback of the sound content data B associated with the layer B while the sound content data A associated with the layer A is being played.

Controlling play/non-play of each piece of sound content data in the overlap region as appropriate on the basis of the degree of priority can play the sound content data A with the higher degree of priority so that the content user 2 can view it satisfactorily.

For example, the content user 2 moving in the region where only the region B is arranged plays only the sound content data B. The content user 2 entering the overlap region in this state can provide such an auditory sensation that playback of the sound content data A newly starts and the playback of the originally played sound content data B is stopped or muted right after entering.

Furthermore, the content user 2 exiting the overlap region in this state and moving in the region where only the region B is arranged again can provide such an auditory sensation that the playback of the sound content data A is stopped or muted and the playback of the sound content data B restarts right after exiting.

In the present embodiment, the playback of the sound content data A corresponds to an embodiment of the first control method according to the present technology. Moreover, the stop or mute processing of the playback of the sound content data B corresponds to an embodiment of the second control method different from the first control method according to the present technology. Moreover, the start of the playback of the sound content data B corresponds to an embodiment of the third control method different from the second control method according to the present technology.

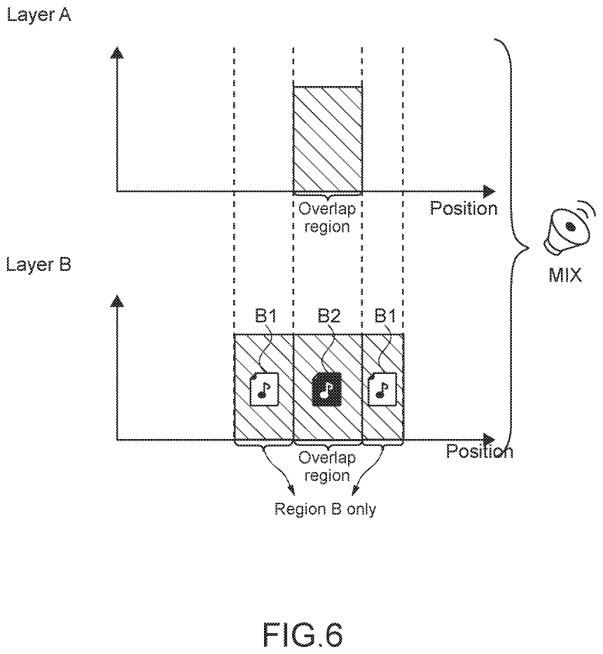

FIG. 6 is a schematic view showing an example of controlling switching of playback contents depending on a degree of priority.

In the example shown in FIG. 6, two types of sound content data B1 and B2 are associated with the region B of the layer B. That is, a plurality of pieces of sound content data is associated with a single region B.

Then, the playback of the sound content data B1 and B2 with the lower degree of priority is switched in the overlap region in accordance with switching of play/non-play of the sound content data A with the higher degree of priority. That is, the playback contents are switched in accordance with switching of play/non-play of the sound content data A.

The playback control unit 11 switches the playback contents, in the overlap region, with respect to the sound content data B associated with the layers B1 and B2 in accordance with switching of play/non-play of the sound content data A associated with the layer A.

Specifically, sound content data 4 with such an auditory sensation that simultaneously plays the sound content data A and the sound content data B2 in the overlap region is generated as synthetic data.

The sound content data B1 is played in the region where only the region B is arranged.

Switching the playback contents of the layer B with the lower degree of priority in the overlap region on the basis of the degree of priority can effectively design conversion and the like of a scene, a scenario, or a landscape for example. This can provide a new user experience. As a matter of course, it can also design other visual effects.

For example, when the content user 2 sees a sight while walking in the Ryogoku-city, the sound content data B1 such as footstep sounds and talking voices of people walking in the city is played. When the content user 2 enters the Ryogoku Kokugikan, the playback of the sound content data A that is narration describing a sumo history starts and the sound content data B2 that is a loud sumo stadium crowd cheering sound is played at the same time.

When the content user 2 exits the Ryogoku Kokugikan, the sound content data B1 such as footstep sounds and talking voices of people walking in the city is played again.

Such playback control can design the atmosphere of a facility with the crowd cheering sound while playing the narration. This can provide a high-quality user experience.

It should be noted that the switching of the playback contents is not limited to switching of playback of different sound content data. Changing the playback time of the sound content data may switch the playback contents.

For example, the sound content data is played from the start in the region where only the region B is arranged. On the other hand, the sound content data is played from a predetermined playback time in the overlap region. Such playback processing may switch the playback contents.

In the present embodiment, the playback of the sound content data A corresponds to an embodiment of the first control method according to the present technology. Moreover, the playback of the sound content data B2 corresponds to an embodiment of the second control method different from the first control method according to the present technology. Moreover, the playback of the sound content data B1 corresponds to an embodiment of the third control method different from the second control method according to the present technology.

The three playback control methods depending on the degree of priority as shown in FIGS. 4 to 6 may be combined. For example, the sound volume of the sound content data 4 having the layer B may be changed in the overlap region and the playback contents may be switched at the same time.

Moreover, a degree of priority may be also set to image data. For example, a degree of priority regarding control on predetermined parameters such as image quality control and image size control may be defined. Moreover, a degree of priority regarding play/non-play of the image and switching of the playback contents of the image may be defined.

In addition, a method for the playback control depending on the degree of priority is not limited.

The acoustic treatment device such as headphones and earbuds corresponds to an embodiment of a content playback apparatus that plays the playback target content in accordance with playback control by the information processing system according to the present technology.

The playback of the playback target content by the content playback apparatus includes presenting a sound effect and an image to the content viewer 2, such as outputting a sound effect in accordance with playback control on the audio data and displaying an image on the display or the like in accordance with playback control on the image data.

Therefore, an image display apparatus such as a display can be used as the content playback apparatus according to the present technology. In addition, any configuration may be employed as the content playback apparatus.

### First Embodiment

As to details of the content providing system 100 shown in FIG. 1, a first embodiment will be described.

### Configuration Example of Content Providing System

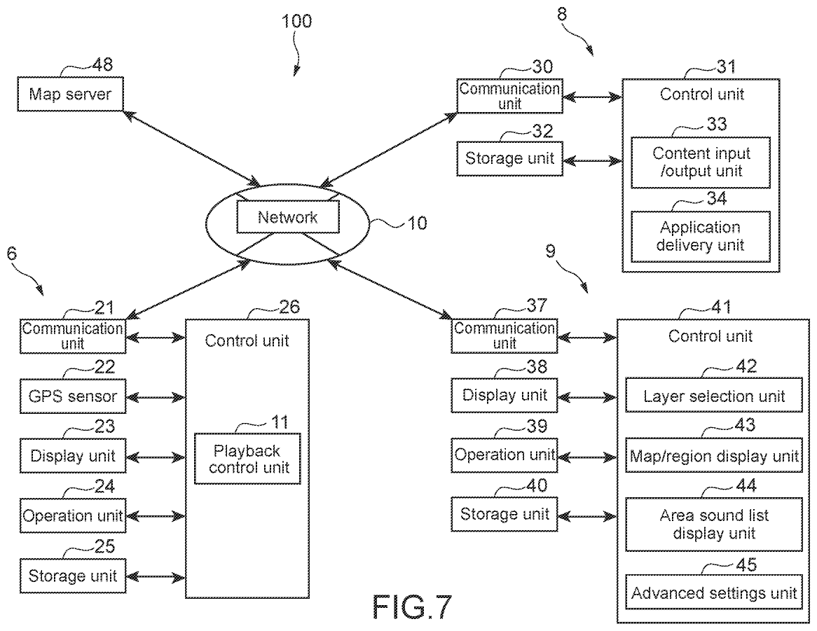

FIG. 7 is a block diagram showing functional configuration examples of the content providing system 100 in the first embodiment.

As shown in FIG. 7, the viewer terminal 6 has a communication unit 21, a GPS sensor 22, a display unit 23, an operation unit 24, a storage unit 25, and a control unit 26.

The communication unit 21 is a device for communicating with other apparatuses. The communication unit 21 may be a communication device such as a wireless LAN module, for example, WiFi, a modem, and a router. The communication unit 21 may be any other communication device.

The display unit 23 displays various types of information such as map information and GUI. The display unit 23 may be any display device such as a liquid-crystal display and an organic electro luminescence (EL) display.

The operation unit 24 is, for example, a keyboard, a pointing device, a touch panel, or another operation device. In a case where the operation unit 24 includes a touch panel, the touch panel can be integrated with the display unit 23.

The storage unit 25 may be a memory, a storage device, or the like.

The control unit 26 has hardware required for a computer configuration such as a processor, a memory, and a storage device. The processor includes a CPU and the like. The memory includes a ROM, a RAM, and the like. The storage device includes an HDD and the like.

In the present embodiment, the processor executing the application program according to the present technology or the like realizes the playback control unit 11 as a functional block shown in FIG. 1. As a matter of course, dedicated hardware such as an integrated circuit (IC) may be used in order to realize the functional blocks.

In the present embodiment, the viewer terminal 6 installs the application program according to the present technology. The content providing server 8 delivers the application program, for example, via the network 10. Then, the storage unit 25 stores the application program.

The content providing server 8 includes a communication unit 30, a control unit 31, and a storage unit 32. The control unit 31 has hardware required for a computer configuration such as a processor, a memory, and a storage device. The processor includes a CPU and the like. The memory includes a ROM, a RAM, and the like. The storage device includes an HDD and the like.

In the present embodiment, the processor executing the program according to the present technology realizes a content input/output unit 33 and an application delivery unit 34 as functional blocks. As a matter of course, dedicated hardware such as an integrated circuit (IC) may be used in order to realize the functional blocks.

The content input/output unit 33 controls the operation of the communication unit 30 to send and receive various types of data stored in the storage unit 32 to/from the information processing apparatus 9 or the like.

The application delivery unit 34 controls the operation of the communication unit 30 to deliver the application program stored in the storage unit 32 to the viewer terminal 6.

The information processing apparatus 9 includes a communication unit 37, a display unit 38, an operation unit 39, a storage unit 40, and a control unit 41.

The control unit 41 has hardware required for a computer configuration such as a processor, a memory, and a storage device. The processor includes a CPU and the like. The memory includes a ROM, a RAM, and the like. The storage device includes an HDD and the like.

In the present embodiment, the processor executing the program according to the present technology realizes a layer selection unit 42, a map/region display unit 43, an area sound list display unit 44, and an advanced settings unit 45 as functional blocks.

The layer selection unit 42, the map/region display unit 43, the area sound list display unit 44, and the advanced settings unit 45 generate various GUIs for producing a sound content map and cause the display unit 38 to display the various GUIs.

In the present embodiment, a GUI for region settings, a GUI for area sound settings, and a GUI for advanced settings are generated in order to set content region information.

The layer selection unit 42 and the map/region display unit 43 generate the GUI for region settings.

The area sound list display unit 44 generates the GUI for area sound settings.

The advanced settings unit 45 generates the GUI for advanced settings.

In the present embodiment, the layer selection unit 42, the map/region display unit 43, the area sound list display unit 44, and the advanced settings unit 45 realize the acquisition unit 12, the setting unit 13, and the display control unit 14 shown in FIG. 1.

Moreover, the layer selection unit 42, the map/region display unit 43, the area sound list display unit 44, and the advanced settings unit 45 realize the output unit according to the present technology.

As shown in FIG. 7, in the present embodiment, the viewer terminal 6, the content providing server 8, and the information processing apparatus 9 are connected to be capable of communicating with a map server 48 via the network 10.

The map server 48 can output map information 18 of various areas. Moreover, the map information 18 is associated with latitude information and longitude information as position information of each point. Here, the position information is not limited to the latitude information and the longitude information. Information other than the latitude information and the longitude information, for example, altitude information or point of interest (POI) information may be used as the position information.

The viewer terminal 6 and the information processing apparatus 9 can acquire map information from the map server 48 and display the map information on each display unit. Moreover, the viewer terminal 6, the content providing server 8, and the information processing apparatus 9 can acquire position information (latitude information and longitude information) of a point designated by the creator 5 or the like with respect to the map information 18.

A panoramic image shot panoramically at each point in the real world may be displayed as the map information 18. For example, a panoramic image or the like shot from Hyakutan dori street may be displayed as the map information. Moreover, an aerial photograph may be displayed as the map information.

For example, downloading software for using the map information 18 from the map server 48 may enable display of the map information, scale change, acquisition of position information of each point depending on the scale, and the like. Alternatively, in a case where an application programming interface (API) for using the map information is open to the public, calling the API may enable use of the map information.

### [GUI for Settings]

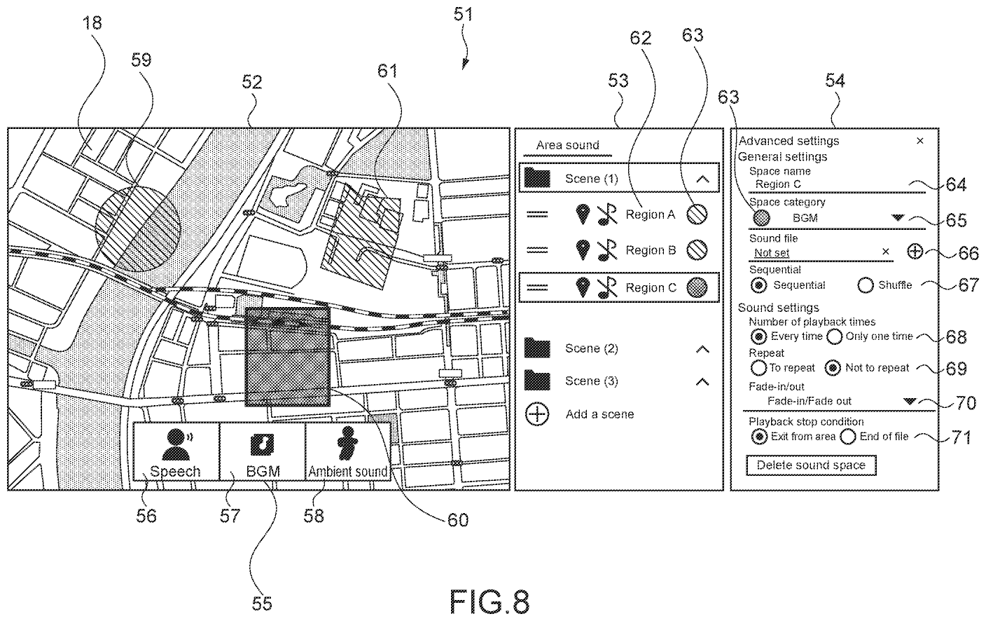

FIG. 8 is a schematic view showing an example of the GUI for settings according to the first embodiment.

For example, a GUI for settings 51 as illustrated in FIG. 8 is displayed on the display unit 38 of the information processing apparatus 9. The creator 5 designates the region 3 and sets the content region information and the map/region display unit 43 displays the region 3 superimposed on the map information 18 via the GUI for settings 51.

In FIG. 8, a GUI 52 for region settings, a GUI 53 for area sound settings, and a GUI 54 for advanced settings are arranged in the stated order from the left as the GUI for settings 51 and are displayed as a single GUI.

The layer selection unit 42 and the map/region display unit 43 generate the GUI 52 for region settings.

The area sound list display unit 44 generates the GUI 53 for area sound settings.

The advanced settings unit 45 generates the GUI 54 for advanced settings.

It should be noted that the area sound is an example of the region 3 designated by the creator 5. The area sound is a kind of region 3 distinguished from a tour sound to be described in a second embodiment. Their name meanings and classification will be described later.

The map information 18, type select buttons 55, and the regions 3 are displayed on the GUI 52 for region settings. The map/region display unit 43 generates the map information 18 and the regions 3. The map/region display unit 43 controls their display on the display unit 38 of the information processing apparatus 9. Moreover, the layer selection unit 42 generates the type select buttons 55. The layer selection unit 42 controls their display on the display unit 38.

The map/region display unit 43 generates the regions 3 and displays the regions 3 superimposed on the map information 18. This enables the creator 5 to intuitively know the position information of the arranged regions 3. It facilitates production of the sound content map 1.

The creator 5 draws a region 3 in a desired shape on the map information 18 by operating a touch pen, a mouse, or the like while checking the GUI 52 for region settings. Accordingly, the creator 5 designates the region 3.

The map information 18 is information about a map of an area where the creator 5 designates the region 3.

The map/region display unit 43 displays the map information 18. Specifically, the communication unit 37 of the information processing apparatus 9 acquires the map information 18 from the map server 48 via the network 10. The map/region display unit 43 generates map information 18 to be displayed on the GUI 52 for region settings on the basis of the acquired map information 18. The map/region display unit 43 generates the map information 18, for example, by setting position and scale of the map to be displayed on the GUI 52 for region settings. Moreover, the map/region display unit 43 causes the display unit 38 to display the generated map information 18.

The position information of the map to be displayed as the map information 18 can be changed arbitrarily. The creator 5 can change the display position arbitrarily, for example, by selecting a place on the map information 18 where no regions 3 are arranged with the mouse and making a drag operation. Alternatively, the creator 5 may change the display position by pressing display position change buttons (not shown) (e.g., up, down, left, and right arrow buttons) arranged on the GUI 52 for region settings.

Moreover, the map scale can also be changed arbitrarily. The creator 5 can change the scale, for example, by scrolling a wheel of the mouse. Alternatively, the creator 5 may change the scale by pressing scale change buttons (not shown) (e.g., positive and negative buttons) arranged on the GUI 52 for region settings.

The map/region display unit 43 determining information input via the operation unit 39 changes the display position and the scale of the map. For example, the map/region display unit 43 determines input instruction, coordinate information, or the like in accordance with an operation on the mouse or the like and generates operation information. Then, the map/region display unit 43 generates map information 18 to be newly displayed on the GUI 52 for region settings on the basis of the operation information and controls its display on the display unit 38.

The type select buttons 55 are buttons for designating type information (layer) to be associated with the regions 3.

In the present embodiment, the type information (layer) is designated in accordance with the type of the sound content data 4. That is, the degree of priority is defined in accordance with the type of the sound content data 4.

In the present embodiment, three types, i.e., speech, BGM, and an ambient sound are defined as the type of the sound content data 4.

Therefore, three types of layers, i.e., a speech layer, a BGM layer, and an ambient sound layer are set as type information respectively associated with the speech, the BGM, and the ambient sound.

Three type select buttons 55 such as a speech button 56, a BGM button 57, and an ambient sound button 58 in the stated order from the left are generated by the layer selection unit 42 and displayed as buttons for designating the speech layer, the BGM layer, and the ambient sound layer respectively.

Examples of the sound content data 4 classified as the speech (hereinafter, simply referred to as speech) include narration and words. For example, narration outlining a facility or area or words uttered by a character related to the facility or the like are designated as the speech.

Examples of the sound content data 4 classified as the BGM (hereinafter, simply referred to as BGM) include a song and a music piece. For example, a music piece appropriate to the atmosphere of the area or a music piece related to the facility is designated as the BGM. As a matter of course, a music style such as vocal music and instrumental music is not limited, and general music pieces can be designated as the BGM.

Examples of the sound content data 4 classified as the ambient sound (hereinafter, simply referred to as the ambient sound) include sounds can be heard in various environments. For example, a rain sound or a wind sound is the ambient sound. Moreover, for example, human voice such as a crowd cheering sound, which is not narration nor words, is also the ambient sound.

In addition, criteria to define the type of the sound content data 4 is not limited, and may be set arbitrarily. Any settings may be employed as the type of the sound content data 4 and the type information corresponding thereto.

For example, the creator 5 selects the speech button 56 for arranging speech in the region 3. Then, the creator 5 draws the region 3 in a desired shape on the map information 18 by operating the touch pen, the mouse, or the like. This enables the creator 5 to set the region 3 where the speech is arranged in the speech layer. That is, the creator 5 can set content region information with the region 3, the speech, and the speech layer (type information) associated with each other.

Moreover, the creator 5 selects the BGM button 57 for arranging BGM in the region 3. Then, the creator 5 draws the region 3 in a desired shape on the map information 18. This enables the creator 5 to set the region 3 where the BGM is arranged in the BGM layer. That is, the creator 5 can set content region information with the region 3, the BGM, and the BGM layer (type information) associated with each other.

Moreover, the creator 5 selects the ambient sound button 58 for arranging an ambient sound in the region 3. Then, the creator 5 draws the region 3 in a desired shape on the map information 18. This enables the creator 5 to set the region 3 where the ambient sound is arranged in the ambient sound layer. That is, the creator 5 can set content region information with the region 3, the ambient sound, and the ambient sound layer (type information) associated with each other.

When the creator 5 selects one of the type select buttons 55, display control, e.g., changing the color of the selected type select button 55, is performed for showing that it has been selected.

The regions 3 are regions that the creator 5 designates on the map information 18.

The creator 5 can designate the regions 3 by drawing on the map information 18 with the mouse, the touch pen, or the like.

The creator 5 selects the type information of the regions 3 on which the creator 5 wishes to perform first drawing by pressing the type select button 55. Accordingly, the layer selection unit 42 selects the type layer.

Next, drawing by the creator 5 causes the map/region display unit 43 to display the regions 3 superimposed on the map information 18.

Drawing the regions 3 by the creator 5 causes the map/region display unit 43 to set the regions 3 on the basis of the map information. Specifically, the map/region display unit 43 calculates the position information of the regions 3 on the basis of the position information (latitude information and longitude information) of the map information 18.

In the present embodiment, the selected layer is associated with the position information of the designated regions 3 and is set as layer region information. Associating the layer region information with the sound content data 4 sets content region information.

The storage unit 40 stores the layer region information.

FIG. 8 illustrates a circular region 59, a rectangular region 60, and a polygonal region 61 as the regions 3.

The shapes of the regions 3 designated by the creator 5 are not limited. For example, the polygonal region 61 as shown in FIG. 8 is designated. Accordingly, for example, the region 3 can be formed in a shape conforming to the outer shape of a building. Moreover, the region 3 can be designated in accordance with the shape of a road or river.

Moreover, in a case where it is only necessary to set a rough range of the region 3 rather than finely designating a shape of the region 3, the circular region 59 or the rectangular region 60 as shown in FIG. 8 may be designated.

A shape of the region 3 is selected, for example, by shape select buttons (not shown). The creator 5 can designate the region 3 in a desired shape by drawing a region 3 after pressing any one of a polygonal shape button, a circular shape button, or a rectangular shape button, for example.

Selecting a kind of polygonal shape such as a triangular or rectangular shape may follow pressing the polygonal shape button. Moreover, setting a diameter of a circle may follow selecting the circular shape button. Moreover, setting a length of a vertical or lateral side of a rectangle may follow selecting the rectangular shape button. In addition, a specific method of designating a shape of the region 3 is not limited.

For example, a drag operation using the mouse draws the region 3. Alternatively, a drawing operation using the touch pen or the like may draw the region 3.

Moreover, for example, pressing an erase button (not shown) after selecting the region 3 may erase the drawn region 3. Alternatively, pressing an escape key or the like of the keyboard may erase the region 3.

Moreover, the drawn region 3 may be moved. For example, making a drag operation on the region 3 moves the region 3. Accordingly, changing only the position of the region 3 without changing its shape makes it unnecessary to draw the same region 3 again after erasing the region 3. It reduces the time for producing the sound content map 1.

In addition, various operations associated with drawing of the region 3 are not limited.

Moreover, selecting the region 3 as in the rectangular region 60 shown in FIG. 8 may display the region 3, emphasized with the outer frame thickened. This enables the creator 5 to intuitively check the currently selected region 3.

Moreover, as shown in FIG. 8, the region 3 may be drawn in a different pattern or color for each layer. This enables the creator 5 to intuitively understand the layer for the region 3 during work.

An area sound list is displayed on the GUI 53 for area sound settings. For the area sound list, the layer region information and the content region information set by the creator 5 are displayed as a list. Specifically, region names 62 respectively associated with the layer region information and the content region information are displayed as the list.

In the example shown in FIG. 8, region names 62 of a region A, a region B, and a region C are displayed in the stated order as the region names 62 associated with the regions 3 drawn on the map information 18.

The region names 62 are associated with the regions 3 by the creator 5 operating the GUI 54 for advanced settings to be described later. A temporary name, e.g., region A or region 1 may be displayed as the region name 62 right after the region is drawn.

The area sound list display unit 44 displays the area sound list. Specifically, the area sound list display unit 44 acquires the layer region information and the content region information from the storage unit 40. Moreover, the region names 62 respectively associated with the acquired layer region information and content region information are displayed as the list.

At this time, the regions 3 respectively included in the layer region information and the content region information are displayed superimposed on the map information 18. The region name 62 associated with the region 3 is emphasized and displayed for example when selecting a region 3 on the map information 18. Moreover, the region 3 associated with the region name 62 is emphasized and displayed when selecting a region name 62 in the area sound list. This enables the creator 5 to easily understand a corresponding relationship between the region 3 and the region name 62.

Moreover, the list of the region names 62 displayed is updated in real time along with drawing or erasing of the region 3 on the map information 18. This can improve the operability for settings of the layer region information and the content region information.

It should be noted that only the layer region information with which the sound content data 4 is not yet associated may be displayed as the list. Moreover, only the content region information with which the sound content data 4 is already associated may be displayed as the list. As a matter of course, the list display of the layer region information only and the list display of the content region information only may be switched to each other.

As shown in FIG. 8, the region names 62 and type information icons 63 showing the layers may be displayed at the same time. In the present embodiment, circular icons each having the same pattern or color as the regions 3 drawn on the map information 18 are displayed as the type information icons 63.

This enables the creator 5 to easily understand which layer is selected as to each of the layer region information and the content region information.

Moreover, the region names 62 may be grouped. In the example shown in FIG. 8, the region A, the region B, and the region C are classified as a group imaging a folder of a scene (1). It achieves layered display.

Moreover, groups different from the scene (1), such as scenes (2) and (3), are also displayed. Selecting each group with the mouse or the like can switch display/non-display of the region names 62 in the group.

Grouping the region names 62 can manage the respective regions 3 easily.

In addition, display contents and operations for the GUI 53 for area sound settings are not limited.

The GUI 53 for area sound settings enables the creator 5 to easily understand the arranged regions 3 in the current state. Moreover, listing the region names 62 can easily manage the arranged regions 3 and the layers for the respective regions 3. This can produce the sound content map 1 with excellent workability.

The GUI 54 for advanced settings displays various types of information about the regions 3.

For example, the creator 5 selecting a region 3 on the map information displays detailed information related to the region 3 on the GUI 54 for advanced settings. Alternatively, selecting a region name 62 displayed on the GUI 53 for area sound settings may display the detailed information on the GUI 54 for advanced settings. In order to realize these processes, the map/region display unit 43, the area sound list display unit 44, and the advanced settings unit 45 cooperatively acquire various types of information about the region 3.

As shown in FIG. 8, in the present embodiment, the GUI 54 for advanced settings displays a space name setting field 64, a space category setting field 65, a sound file setting field 66, a sequential setting field 67, a number-of-playback times setting field 68, a repeat setting field 69, a fade-in/out setting field 70, and a playback stop condition setting field 71.

The creator 5 can perform various advanced settings related to the region 3 by operating each item of the GUI 54 for advanced settings.

The advanced settings unit 45 displays the GUI 54 for advanced settings. Specifically, the advanced settings unit 45 acquires the layer region information and the content region information from the storage unit 40. Based on the acquired content region information and the like, the advanced settings unit 45 extracts various types of information about the region 3, for example, sound content data 4 associated with the region 3. Then, the advanced settings unit 45 generates a GUI 54 for advanced settings on the basis of the extracted information. Moreover, the advanced settings unit 45 controls the display on the display unit 38 of the generated GUI 54 for advanced settings.

As a matter of course, information not yet set is displayed to be blank. For example, when the layer region information is selected, that portion is blank because the sound content data 4 is not yet set.

Moreover, when the creator 5 performs various settings regarding the region 3 by operating the GUI 54 for advanced settings, the advanced settings unit 45 associates the settings. For example, when the creator 5 designates sound content data 4 to be associated with the regions 3, the advanced settings unit 45 associates the designated sound content data 4 with the region 3 and the layer stored in the storage unit 40. Moreover, when the creator 5 designates the number of playback times for the region 3, the advanced settings unit 45 associates the designated number of playback times with the region 3 and the type information stored in the storage unit 40.

The space name setting field 64 is an item for setting a region name 62.

The creator 5 can input a desired region name 62 in the space name setting field 64.

Setting region names 62 in this manner enables the creator 5 to easily understand and manage each region 3.

The space category setting field 65 is an item for displaying and setting a layer to be associated with the region 3.

The space category setting field 65 displays a layer selected when designating the region 3. For example, operating a pull down button can select the speech layer, the BGM layer, and the ambient sound layer anew.

As shown in FIG. 8, the type information icon 63 may be displayed at the same time as the layer. This enables the creator 5 to intuitively understand the currently set layer.

The sound file setting field 66 is an item for designating sound content data 4 to be associated with the region 3.

For example, selecting an add button (positive button) as shown in FIG. 8 displays a selection screen for an audio file. The creator 5 can set an audio file as the sound content data 4, for example, by designating the audio file stored in the information processing apparatus 9 on the selection screen. Moreover, the content providing server 8 may store audio files and each creator 5 may designate an audio file.

A plurality of audio files may be designated with an identical region 3 as the sound content data 4. In this case, a plurality of pieces of sound content data 4 is associated with the region 3.

In a phase where drawing is done on the GUI 52 for region settings, only the region 3 and the layer are associated with each other and the layer region information not associated with the sound content data 4 is stored in the storage unit 40. Setting the sound content data 4 in the sound file setting field 66 provides the content region information with the regions 3, the sound content data 4, and the layer associated with each other. Then, the advanced settings unit 45 stores them in the storage unit 40.

This associates the region 3 designated by the creator 5 with the sound content data 4 and the layer and sets the content region information.

In the present embodiment, the advanced settings unit 45 associates the type information with the sound content data 4 in accordance with the type of the sound content data 4. Thus, the type of the sound content data 4 designated by the creator 5 includes at least one of speech, BGM, or an ambient sound. For example, in a case where the type information of the region 3 is speech, the sound content data 4 whose type is the speech is designated.

Audio duration, volume, extension, and the like of the designated audio file are not limited.

The sequential setting field 67 is an item for setting a playback order of the sound content data 4.

Setting the playback order is a function valid in a case where the plurality of pieces of sound content data 4 is associated with the region 3, for example. Thus, the advanced settings unit 45 may perform control to display the sequential setting field 67 only in a case where the plurality of pieces of sound content data 4 is associated in the sound file setting field 66.

As shown in FIG. 8, in the present embodiment, “sequential” or “shuffle” can be selected as the playback order.

In a case where “sequential” is selected, the playback control unit 11 of the viewer terminal 6 plays a plurality of pieces of sound content data 4 in a predetermined order when the content user 2 enters the region 3.

Specifically, playback is performed in an order of the creator 5 designating the sound content data 4 in the sound file setting field 66, for example. In this case, the advanced settings unit 45 associates the playback order with the sound content data 4 or the like. Then, the storage unit 40 stores them.

Moreover, in a case where “sequential” is selected, a screen for designating the playback order may be additionally displayed.

In a case where “shuffle” is selected, the playback control unit 11 of the viewer terminal 6 plays the sound content data 4 selected at random from a plurality of pieces of sound content data 4. Specifically, the playback control unit 11 decides at random the sound content data 4 to be played immediately when the content user 2 enters the region 3. Moreover, the playback control unit 11 plays the single piece of sound content data 4 decided at random.

The random decision for the once played sound content data 4 may be controlled so as to prevent it from being played again until a predetermined time elapses. That is, the sound content data 4 may be excluded from the random decision until the predetermined time elapses.

The number-of-playback times setting field 68 is an item for setting an upper limit for the number of playback times of the sound content data 4. As shown in FIG. 8, in the present embodiment, “every time” or “only one time” can be selected as the upper limit for the number of playback times.

In a case where “every time” is selected, the sound content data 4 is played when the content user 2 enters the region 3.

In a case where “only one time” is selected, the sound content data 4 is played only one time. Specifically, playback is performed only one time in total, for example, between the start and stop of the application program according to the present technology.

Otherwise, a predetermined number of times may be set as the upper limit for the number of playback times, for example. In this case, the playback control unit 11 of the viewer terminal 6 counts the number of playback times in a case of playing the sound content data 4. When the number of playback times counted reaches the upper limit for the number of playback times, playback cancel control is performed. The number of playback times is counted in total while executing the application program according to the present technology, for example. Moreover, clearing a viewing history of a tour in the application program resets the number of playback times counted to zero.

The repeat setting field 69 is an item for settings related to repeat playback of the sound content data 4. As shown in FIG. 8, in the present embodiment, “No” or “Yes” of repeat playback can be selected.

In a case where “No” is selected, the sound content data 4 is played only one time every time the content user 2 enters the region 3.

In a case where “Yes” is selected, the sound content data 4 is infinitely looped and played while the content user 2 stays in the region 3.

Otherwise, for example, a predetermined number of times may be set as the number of repeat playback times. In this case, the playback control unit 11 of the viewer terminal 6 counts the number of playback times during the playback of the sound content data 4. When the number of playback times counted reaches the upper limit for the number of playback times, playback cancel control is performed. The number of playback times is counted in total while the content user 2 stays in the region 3. When the content user 2 exits the region 3, the number of playback times counted is reset to zero.

The fade-in/out setting field 70 is an item for settings related to fade-in and fade-out.

For example, the creator 5 selects one of four setting items, i.e., “fade-in/out”, “fade-in only”, “fade-out only”, and “none” arranged in pull down form.

In a case where the “fade-in/out” is selected, the playback control unit 11 performs a fade-in process when starting the playback of the sound content data 4. Specifically, the playback of the sound content data 4 is started, gradually increasing the sound volume from zero. Moreover, the playback control unit 11 performs a fade-out process when stopping the playback of the sound content data 4. Specifically, the playback of the sound content data 4 is stopped, gradually reducing the sound volume to zero.

In a case where the “fade-in only” is selected, the playback control unit 11 performs a fade-in process only.

In a case where the “fade-out only” is selected, the playback control unit 11 performs only the fade-out process.

In a case where “none” is selected, normal playback is performed without the fade-in and fade-out processes.

The playback stop condition setting field 71 is an item for setting a condition to stop the playback of the sound content data 4. As shown in FIG. 8, in the present embodiment, “outside the area” or “end of the file” can be selected as the condition to stop the playback with a radio button.

In a case where the “outside the area” is selected, the playback of the sound content data 4 is stopped when the content user 2 exits the region 3.

In a case where the “end of the file” is selected, the playback is stopped when the audio data set as the sound content data 4 is played to the end.

Moreover, it may be possible to designate the sound volume of the set sound content data 4 in a case where different sound content data 4 with a higher degree of priority than a degree of priority of the set sound content data 4 is being played.

Otherwise, the GUI 54 for advanced settings enables the creator 5 to perform various settings regarding the region 3. This can produce the sound content map 1 reflecting the ideas of the creator 5.

It should be noted that the above-mentioned setting items are merely exemplary and specific configurations of the GUI 54 for advanced settings are not limited.

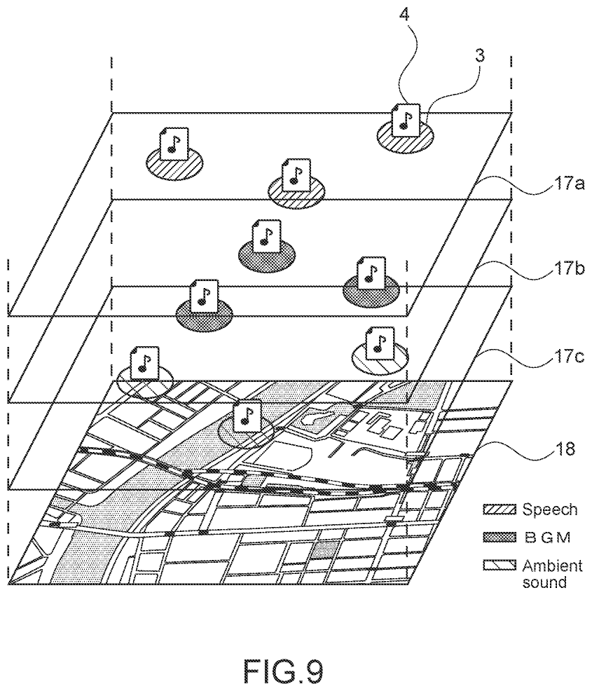

FIG. 9 is a schematic view for describing the type information and the degree of priority in the first embodiment.

In FIG. 9, a plurality of layers 17 is set as the type information. Specifically, a speech layer 17a, a BGM layer 17b, and an ambient sound layer 17c are set.

In the present embodiment, the advanced settings unit 45 associates the speech (the sound content data 4 classified as the speech) with the speech layer 17a with a first degree of priority. That is, the regions 3 on which speech is wished to be arranged are arranged in the speech layer 17a.

Moreover, the BGM (sound content data 4 classified as the BGM) is associated with the BGM layer 17b with a second degree of priority different from the first degree of priority. That is, the regions 3 on which BGM is wished to be arranged are arranged in the BGM layer 17b.

Moreover, the ambient sound (sound content data 4 classified as the ambient sound) is associated with the ambient sound layer 17c with a third degree of priority different from each of the first degree of priority and the second degree of priority. That is, the regions 3 on which ambient sounds wished to be arranged are arranged in the ambient sound layer 17c.

In this manner, degrees of priority different from each other (first to third degrees of priority) may be set in three different layers 17.

In the present embodiment, the first degree of priority is set as the highest degree of priority and the second degree of priority is set as a degree of priority lower than the first degree of priority. Moreover, the third degree of priority is set as a degree of priority lower than the second degree of priority.

Therefore, the speech layer 17a with the first degree of priority is associated with the speech and the BGM layer 17b with the second degree of priority lower than the first degree of priority is associated with the BGM. The ambient sound (sound content data 4 classified as the ambient sound) is associated with the ambient sound layer 17c with the third degree of priority lower than the second degree of priority.

That is, the speech layer has the highest degree of priority, the BGM layer has the second highest degree of priority, and the ambient sound layer has the third highest degree of priority. Each layer 17 is associated with the sound content data 4 of the corresponding type.

As a matter of course, the order of the degrees of priority is not limited. For example, the degrees of priority may be conversely defined so that the ambient sound layer has the highest degree of priority and the BGM layer and the speech layer have degrees of priority becoming lower in the stated order.

In addition, the creator 5 can set the degrees of priority arbitrarily, considering the type of the sound content data 4 and the like.

In the example shown in FIG. 9, three circular regions 3 associated with the speech 4 are arranged in the speech layer 17a at the top.

Moreover, three circular regions 3 associated with the BGM is arranged in the second BGM layer 17b from the top.

Moreover, three circular regions 3 associated with the ambient sounds are arranged in the third ambient sound layer 17c from the top.

The playback control based on the degree of priority as described above is performed for example on the basis of the degree of priority of each layer.

In the present embodiment, the playback control unit 11 controls the sound volume depending on the degree of priority.

That is, the playback is controlled to reduce the sound volume of the sound content data 4 with the lower degree of priority while the sound content data 4 with the higher degree of priority is being played in the overlap region as in the example shown in FIG. 4.

The speech layer has a higher degree of priority between the speech layer and the BGM layer. Thus, the sound volume of the BGM is controlled to lower when playing the speech.

In this case, the speech layer corresponds to the layer A (first type information) in FIG. 3. Moreover, the BGM layer corresponds to the layer B (second type information).

Since speech often includes important information such as words and narration, it is often desirable to play them so that the content user 2 can easily hear them. On the other hand, BGM often includes relatively less important information such as a music piece for designing the atmosphere of the scene or the like.

As shown in FIG. 9, setting the degree of priority for the speech layer to be higher than the degree of priority for the BGM layer enables the content user 2 to clearly hear the speech and recognize important information.

The speech layer has a higher degree of priority between the speech layer and the ambient sound layer. Thus, the sound volume of the ambient sound is controlled to lower when playing the speech.

In this case, the speech layer corresponds to the layer A (first type information) in FIG. 3. Moreover, the ambient sound layer corresponds to the layer B (second type information).

Also, the sound content data 4 classified as the ambient sound often includes relatively less important information such as a sound effect for designing the atmosphere of the scene or the like. Setting the degree of priority for the speech layer to be higher than the degree of priority for the ambient sound layer enables the content user 2 to clearly hear the speech and recognize important information.

The BGM layer has a higher degree of priority between the BGM layer and the ambient sound layer. Thus, the sound volume of the ambient sound is controlled to lower when playing the BGM.

In this case, the BGM layer corresponds to the layer A (first type information) in FIG. 3. Moreover, the ambient sound layer corresponds to the layer B (second type information).

Setting the degree of priority for the BGM layer to be higher than the degree of priority for the ambient sound layer can satisfactorily design the atmosphere of the scene or the like with the music piece, for example. Moreover, the content user 2 can fully enjoy a theme song or the like.

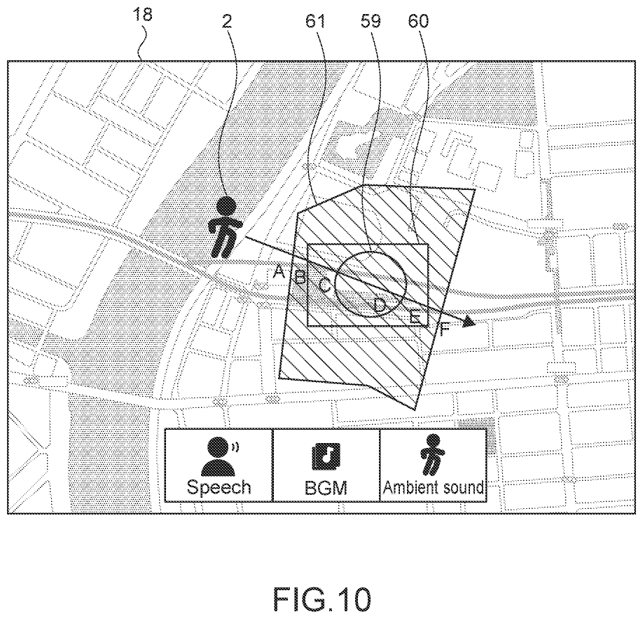

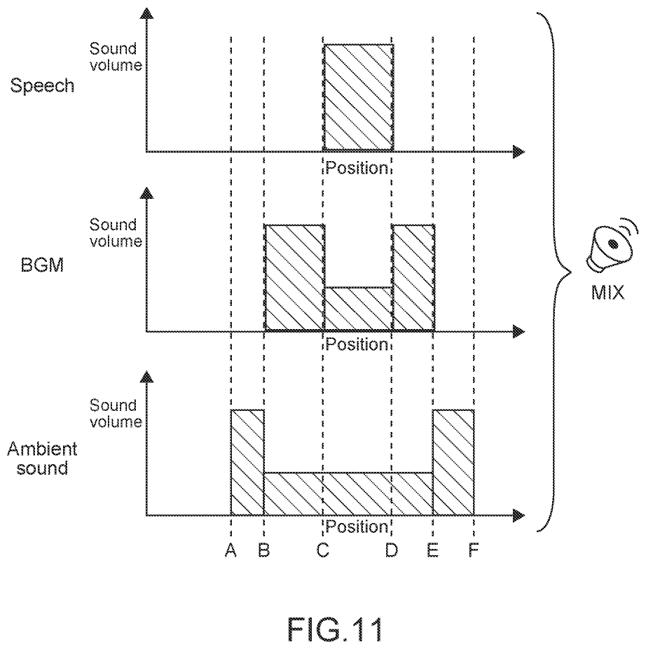

FIGS. 10 and 11 are schematic views showing an example of sound volume control based on the degree of priority.

FIG. 10 shows a movement path of the content user 2.

As shown in FIG. 10, a plurality of regions 3 is arranged on the map information 18. Specifically, a circular region 59 arranged in the speech layer, a rectangular region 60 arranged in the BGM layer, and a polygonal region 61 arranged in the ambient sound layer are arranged.

The rectangular region 60 arranged in the BGM layer includes the circular region 59 arranged in the speech layer. The polygonal region 61 arranged in the ambient sound layer includes the rectangular region 60 arranged in the BGM layer. Thus, the polygonal region 61 arranged in the ambient sound layer also includes the circular region 59 arranged in the speech layer.

It is assumed that the content user 2 moves along the movement path shown in FIG. 10.

First of all, the content user 2 enters the polygonal region 61 arranged in the ambient sound layer at Point A.

Next, the content user 2 moves in the region 61 arranged in the ambient sound layer and enters the rectangular region 60 arranged in the BGM layer at Point B.

Next, the content user 2 moves in the rectangular region 60 arranged in the BGM layer and enters the circular region 59 arranged in the speech layer at Point C.

Next, the content user 2 moves in the circular region 59 arranged in the speech layer and exits the circular region 59 arranged in the speech layer at Point D.

Next, the content user 2 moves in the rectangular region 60 arranged in the BGM layer and exits the rectangular region 60 arranged in the BGM layer at Point E.

At last, the content user 2 moves in the polygonal region 61 arranged in the ambient sound layer and exits the polygonal region 61 arranged in the ambient sound layer at Point F.

Therefore, the content user 2 sequentially moves in the regions below.

(1) The polygonal region 61 arranged in the ambient sound layer (between Points A and B)

(2) The overlap region of the polygonal region 61 arranged in the ambient sound layer and the rectangular region 60 arranged in the BGM layer (between Points B and C)

(3) The overlap region of the polygonal region 61 arranged in the ambient sound layer, the rectangular region 60 arranged in the BGM layer, and the circular region 59 arranged in the speech layer (between Points C and D)

(4) The overlap region of the polygonal region 61 arranged in the ambient sound layer and the rectangular region 60 arranged in the BGM layer (between Points D and E)

(5) The polygonal region 61 arranged in the ambient sound layer (between Points E and F)

FIG. 11 shows graphs of the sound volume associated with the position of the content user 2.

FIG. 11 shows graphs related to the speech, the BGM, and the ambient sound.

As shown in FIG. 11, only the ambient sound is played at a predetermined sound volume when the content user 2 is located between Points A and B.

The ambient sound and the BGM are played when the content user 2 is located between Points B and C.

The degree of priority of the ambient sound is lower than the degree of priority of the BGM. Therefore, the playback is controlled to reduce the sound volume of the ambient sound. That is, the sound volume of the ambient sound is lower than the sound volume between Points A and B.

The ambient sound, the BGM, and the speech are played when the content user 2 is located between Points C and D.

The degree of priority of the BGM is lower than the degree of priority of the speech. Therefore, the playback is controlled to reduce the sound volume of the BGM. That is, the sound volume of the BGM is lower than the sound volume between Points B and C.

The degree of priority of the ambient sound is lower than the degree of priority of the speech. Moreover, the degree of priority of the ambient sound is lower than the degree of priority of the BGM. Thus, the playback is controlled to reduce the sound volume of the ambient sound. That is, the sound volume of the BGM is controlled to be the same as the sound volume between Points B and C.

The ambient sound and the BGM are played when the content user 2 is located between Points D and E.

As between Points B and C, the playback is controlled to reduce the sound volume of the ambient sound. That is, the sound volume of the ambient sound is controlled to be the same as the sound volume between Points C and D.

Moreover, the sound volume of the BGM returns to the original sound volume. The sound volume of the BGM is controlled to be the same as the sound volume between Points B and C.

Only the ambient sound is played at the predetermined sound volume when the content user 2 is located between Points E and F.

The sound volume of the ambient sound returns to the original sound volume. The sound volume of the ambient sound is controlled to be the same as the sound volume between Points A and B.

As described above, in a case of playing the plurality of pieces of sound content data 4 different in type information, the sound volume of the sound content data 4 with the lower degree of priority is controlled to lower by comparing the degrees of priority of the sound content data 4.

In the example shown in FIG. 11, the sound content data 4 at the highest level is played at the predetermined sound volume (maximum reference sound volume). All the pieces of sound content data 4 at the lower level are played at a sound volume (minimum reference sound volume) lower than the predetermined sound volume. That is, after setting the maximum reference sound volume and the minimum reference sound volume, the sound content data 4 is played at the maximum reference sound volume in a case where it is at the highest level and the sound content data 4 is played at the minimum reference sound volume in a case where it is not at the highest level.

The present technology is not limited thereto. The playback may be controlled to vary in sound volume by comparing the degrees of priority between the plurality of pieces of sound content data 4 not at the highest level. For example, the sound volume of the ambient sound may be controlled to be lower than the sound volume of the BGM between Points C and D in FIG. 11.

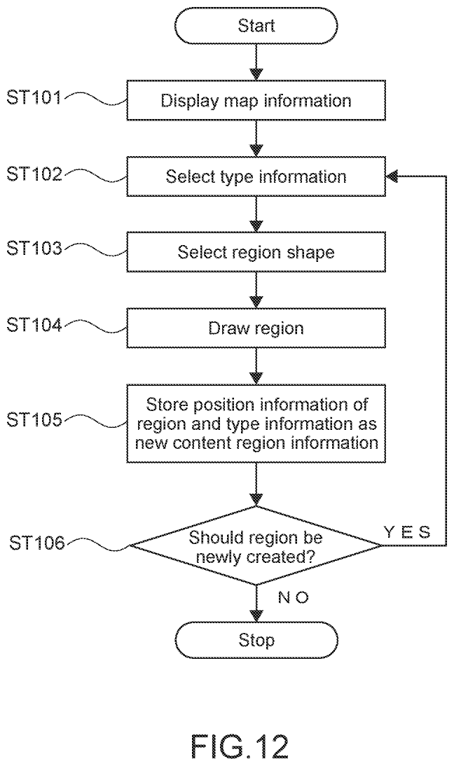

FIG. 12 is a flowchart showing a processing example related to the settings of the regions 3 and the layer.

The map/region display unit 43 displays the map information 18 on the GUI 52 for region settings (Step 101).

The creator 5 selects a layer to be associated with regions 3 (Step 102).

The creator 5 uses the type select buttons 55 generated by the layer selection unit 42 for selecting the layer. When the creator 5 selects one of the type select buttons 55, the layer selection unit 42 selects the layer associated with the selected type select button 55 and the map/region display unit 43 acquires the layer. The layer selection using the layer selection unit 42 corresponds to type information generation.

The creator 5 selects a shape of a region 3 to be drawn on the map information 18 (Step 103).

The creator 5 uses, for example, the shape select buttons for selecting the shape of the region 3. For example, when the creator 5 presses one of the shape select buttons, the map/region display unit 43 acquires shape information of the selected shape. The map/region display unit 43 performs processing related to drawing of the region 3 on the basis of the shape information.

The creator 5 draws the region 3 (Step 104).

When the creator 5 draws the region 3, the map/region display unit 43 displays the region 3 superimposed on the map information 18. Moreover, the position information of the region 3 is calculated.

The position information of the region 3 and the layer are stored as new content region information (Step 105).

The map/region display unit 43 associates the position information of the region 3 with the layer. Then, the storage unit 40 of the information processing apparatus 9 temporarily stores them as layer region information.

In a case where a region 3 should be newly created (YES in Step 106) and the creator 5 designates the region 3, the creator 5 selects a layer again.

In a case where no region 3 should be newly created (NO in Step 106), the processing ends.

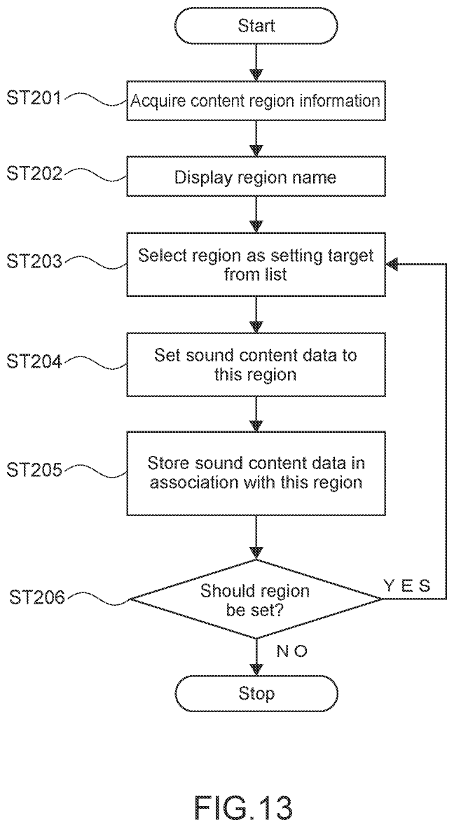

FIG. 13 is a flowchart showing a processing example related to settings of the sound content data 4.

FIG. 13 shows a method of setting the sound content data 4 to the region 3 as an example. Note that similar processing can set the region names 62, the playback order, and the like.

The area sound list display unit 44 acquires layer region information from the storage unit 40 (Step 201). For example, when a region 3 displayed on the GUI 52 for region settings is selected, the area sound list display unit 44 acquires layer region information associated with the region 3.

The region names 62 are displayed on the GUI 53 for area sound list settings (Step 202).

The area sound list display unit 44 acquires the region names 62 associated with the region 3 on the basis of the acquired layer region information. Moreover, the acquired region names 62 are displayed as the list.

The region names 62 and the type information icon 63 showing the layer may be displayed at the same time.

The creator 5 selects a region 3 as a setting target (Step 203).

The creator 5 designates the region 3 as the setting target by selecting one of the region names 62 displayed on the GUI 53 for area sound settings. This designation causes various types of detailed information related to the region 3 to be displayed on the GUI 54 for advanced settings.

The sound content data 4 is set to the selected region 3 (Step 204).

The creator 5 designates an audio file as the sound content data 4 in the sound file setting field 66 on the GUI 54 for advanced settings.

The sound content data 4 is stored in association with the region 3 (Step 205).

The advanced settings unit 45 stores the designated sound content data 4 in association with the region 3 and the layer stored in the storage unit 40. That is, the advanced settings unit 45 stores the content region information.

In a case where there is a region 3 to which sound content data 4 should be set (YES in Step 206) and the creator 5 designates the sound content data 4, the creator 5 selects the region 3 on the GUI 53 for area sound settings again.

In a case where there is no region 3 to which sound content data 4 should be set (NO in Step 206), the processing ends.

Hereinabove, in the content providing system 100 according to the present embodiment, the regions 3, the sound content data 4, and the type information indicating the playback control types (layers) are associated with each other and set as the content region information. This can provide a new user experience.

Applying the present technology enables the creator 5 to produce the sound content map 1. The content user 2 entering one of the regions 3 arranged on the sound content map 1 plays the sound content data 4, for example, narration, BGM, and/or a sound effect, associated with an area or facility.

Setting degrees of priority to the sound content data 4 can realize various types of playback control, for example, making a control to increase the sound volume of the sound content data 4 in the degree of priority. As a result, a high-quality new user experience can be provided.

### Second Embodiment

The second embodiment will be described as to details of the content providing system 100 shown in FIG. 1.

Hereinafter, differences from the first embodiment will be mainly described, and descriptions of portions similar to configurations and actions of the content providing system 100 described in the first embodiment above will be omitted or simplified.

In the present embodiment, a region other than the region 3 designated by the creator 5 is associated with the sound content data 4 and the type information and set as the content region information. Specifically, the creator 5 designating the region 3 associates an external region that is a region outside the designated region 3 with the sound content data 4 and the type information and sets them as the content region information.

Hereinafter, the region 3 designated by the creator 5 will be referred to as an area sound 74.

Moreover, the external region of the region 3 designated by the creator 5 will be referred to as a tour sound 75.

That is, the tour sound 75 is a region outside the area sound 74.

For example, a region of the region associated with the entire map information 18, which excludes a portion that is the area sound 74, is set as the tour sound 75.

For example, map information 18 of the entire region of Chiyoda-ku in Tokyo is acquired as the map information 18. In such a case, the tour sound 75 is a region 3 of the entire region 3 of Chiyoda-ku, which has no area sound 74 set.

Moreover, in this case, the sound content data 4 associated with the tour sound 75 is played immediately when the content user 2 enters Chiyoda-ku.

As a matter of course, a valid range for area setting may be set to the acquired map information 18. For example, in this case, the external region of the region 3 designated by the creator 5 serves as the tour sound 75 within the valid range.

### [Tour Sound]

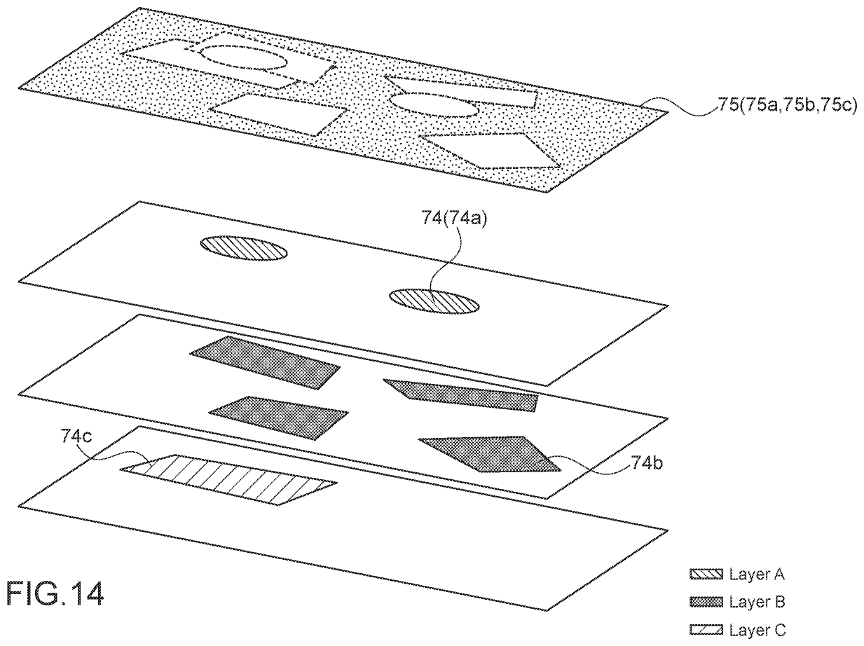

FIG. 14 is a schematic view for describing the tour sound 75.

In FIG. 14, a layer A, a layer B, and a layer C are set as the type information. Area sounds 74 and tour sounds 75 are set to each layer. Moreover, in the present embodiment, settings are made so that the layer A has the highest degree of priority, the layer B has the second highest degree of priority, and the layer C has the third highest degree of priority.

The creator 5 designating a region 3 sets the region 3 as the area sound 74 and at the same time sets the entire external region of the region 3 as the single tour sound 75.

For example, two circular regions 3 are designated in the layer A as shown in FIG. 14. The two circular regions 3 are set as area sounds 74a.

Four rectangular regions 3 are designated in the layer B. The four rectangular regions 3 are set as area sounds 74b.

A single rectangular region 3 is designated in the layer C. The single rectangular region 3 is set as the area sound 74c.

As shown in FIG. 14, the tour sound 75 is set to a region without any area sound 74. That is, a region where no area sounds 74a, 74b, and 74c are arranged is set as the tour sound 75.

As in the area sound 74, the tour sound 75 is associated with the type information. In the present embodiment, a tour sound 75a is associated with the layer A. Moreover, a tour sound 75b is associated with the layer B. Moreover, a tour sound 75c is associated with the layer C.

As a matter of course, the tour sound 75a, the tour sound 75b, and the tour sound 75c are regions 3 having the same shape.

The tour sounds 75a to 75c can be associated with the sound content data 4 and the type information (layers) and set as the content region information.

Setting the tour sound 75 can play the sound content data 4 in accordance with the position of the content user 2 also in a region other than the region 3 designated by the creator 5. Moreover, defining the degrees of priority in the layers can realize various types of playback control as described above with respect to the sound content data 4 in each layer. This can provide a high-quality new user experience.

For example, a theme song or the like of the sound content map 1 is associated with the tour sound 75. This enables the content user 2 to be immersed in this virtual content and more fully enjoy the sound content map 1. As a matter of course, the present technology is not limited to such an application.

It should be noted that the tour sound 75 is set to the region without any area sound 74. Therefore, the speech, the BGM, and the ambient sound can be arranged in the tour sound 75 without interfering with the playback of the audio data (speech, BGM, and ambient sound) in the area sound 74.

The tour sound 75 corresponds to an embodiment of the region other than the region designated by the user according to the present technology.

### Configuration Example of Content Providing System

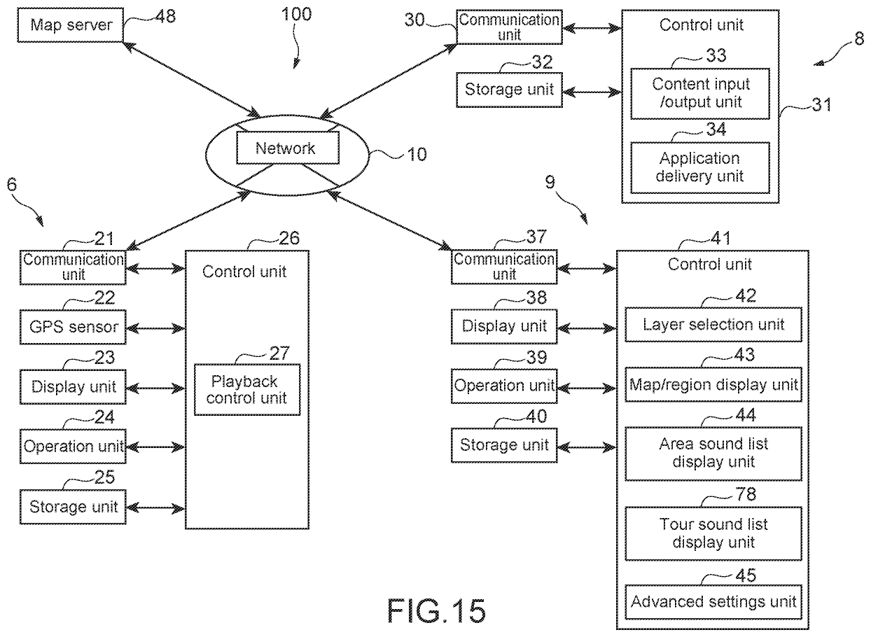

FIG. 15 is a block diagram showing functional configuration examples of the content providing system 100 in the second embodiment.

Configurations and actions of the configuration example shown in FIG. 15, which exclude a tour sound list display unit 78 of the information processing apparatus 9, are similar to the contents described in the first embodiment above. Therefore, the descriptions will be omitted.

For example, the processor of the control unit 41 of the information processing apparatus 9 executing the program according to the present technology realizes the tour sound list display unit 78.

The tour sound list display unit 78 generates a GUI 79 for tour sound settings.

### [GUI for Settings]

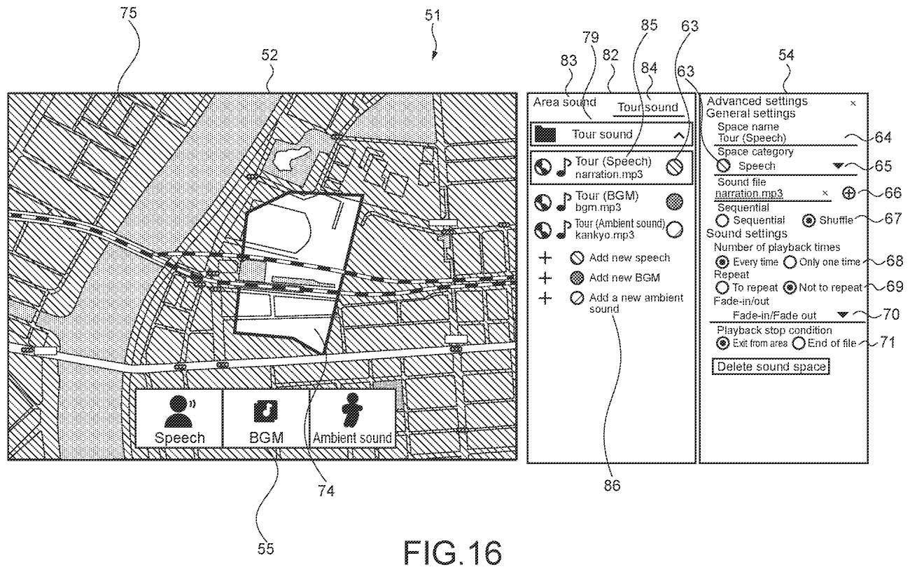

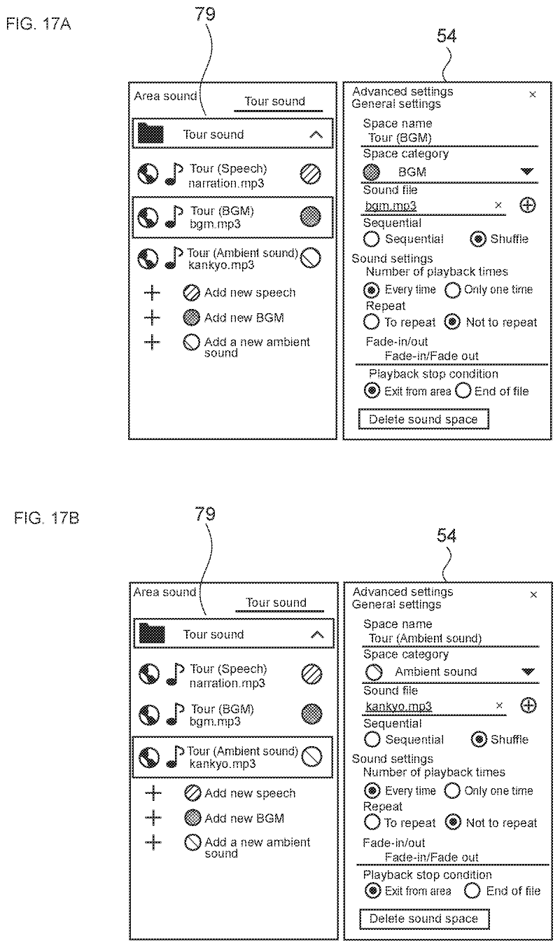

FIGS. 16 and 17 are schematic views showing an example of the GUI for settings 51 in the second embodiment.

As shown in FIG. 16, a GUI 52 for region settings, a GUI 82 for area sound/tour sound settings, and a GUI 54 for advanced settings are arranged in the stated order from the left as the GUI for settings 51 and displayed as a single GUI.

A map information 18, type select buttons 55, and a region 3 are displayed on the GUI 52 for region settings.

In the present embodiment, either an area sound 74 or a tour sound 75 is displayed as the region 3.

In the example shown in FIG. 16, the tour sound 75 is displayed as a patterned region 3 on the map information 18. That is, a polygonal portion without any pattern corresponds to a region combining area sounds 74a, 74b, and 75c designated by the creator 5.

The display of the area sound 74 or the tour sound 75 can be switched. Specifically, pressing a switching button (not shown) or the like switches the display settings.

For example, the creator 5 can draw an area sound 74 under the settings to display the area sound 74, and then switch the display settings to display the tour sound 75 and check the shape of the arranged tour sound 75.

The display settings may be switched in conjunction with selecting an area sound tab 83 and a tour sound tab 84 of the GUI 82 for area sound/tour sound settings to be described later.

In order to realize these processes, the map/region display unit 43, the area sound list display unit 44, and the tour sound list display unit 78 cooperatively acquire various types of information about the display settings.

The map/region display unit 43 associates the tour sound 75 with the sound content data 4 and the layer and sets the content region information.

Specifically, first of all, the creator 5 presses one of the type select buttons 55 and draws an area sound 74. As in the first embodiment, the map/region display unit 43 stores layer region information with position information of the drawn area sound 74 associated with type information in the storage unit 40 of the information processing apparatus 9.

Next, the map/region display unit 43 calculates position information of the tour sound 75 on the basis of the position information of the area sound 74. For example, the map/region display unit 43 calculates longitude range and latitude range of the tour sound 75 from longitude range and latitude range of the entire map information 18 as a range of the area sound 74 (region combining the area sound 74a, the area sound 74b, and the area sound 75c), which excludes the longitude range and latitude range.

The storage unit 40 associates the calculated position information of the tour sound 75 with each layer and stores them as layer region information.

The GUI 82 for area sound/tour sound settings displays a list of the region names 62.

As shown in FIG. 16, the area sound tab 83 and the tour sound tab 84 are arranged on the GUI 82 for area sound/tour sound settings.

The creator 5 selecting the area sound tab 83 displays the GUI 53 for area sound settings as in the first embodiment.

Moreover, the creator 5 selecting the tour sound tab 84 displays the GUI 79 for tour sound settings.

The tour sound list display unit 78 controls the display of the GUI 79 for tour sound settings. Specifically, the tour sound list display unit 78 acquires the layer region information from the storage unit 40. Moreover, on the basis of the acquired layer region information, the set tour sound 75 is extracted, and tour sound names 85 associated with the tour sound 75 are displayed as a list.

In the example shown in FIG. 16, the creator 5 selects the tour sound tab 84 and the GUI 79 for tour sound settings is displayed.

In the example shown in FIG. 16, three tour sound names 85 of a tour (speech), a tour (BGM), and a tour (ambient sound) are displayed in the stated order as set tour sounds 75 associated with the region names 62.

It should be noted that also in the present embodiment, a speech layer, a BGM layer, and an ambient sound layer are employed as the type information. The tour (speech) is associated with the speech layer. Similarly, the tour (BGM) is associated with the BGM layer and the tour (ambient sound) is associated with the ambient sound layer.

That is, one tour sound name 85 is displayed for each layer, i.e., a total of three tour sound names 85 are displayed.

The creator 5 can change the tour sound names 85 by operating the space name setting field 64 of the GUI 54 for advanced settings.

It should be noted that in the present embodiment, pressing one of add buttons 86 of the tour sound 75 sets the tour sound 75 and displays the tour sound name 75.

For example, in a phase where the creator 5 draws the area sound 74, the tour sound 75 is not set and the tour sound name 85 is not displayed. The tour sound 75 is set and displayed only after the creator 5 presses one of the add buttons 86 displayed on the GUI 79 for tour sound settings.

Three kinds of buttons, i.e., “add a new speech”, “add a new BGM”, and “add a new ambient sound” as shown in FIG. 16 are displayed as the add buttons 86 on the GUI 79 for tour sound settings.

As in the example shown in FIG. 16, the three kinds of add buttons 86 cannot be selected in a case where three kinds of tour sounds 75 are already set. In this case, the add buttons 86 may be displayed to be inactive in gray color or the like.

As a matter of course, the add buttons 86 does not need to be displayed in a case where the tour sound 75 is set.

In a case where no tour sounds 75 are set to each layer, the add buttons 86 are displayed to be active with respect to the layers without any tour sound 75 set. The creator 5 can select one of the add buttons 86 displayed to be active and set the tour sound 75.

The creator 5 can select each of tour sound names 85 displayed on the GUI 79 for tour sound settings.

In the example shown in FIG. 16, a tour (speech) is selected and displayed, emphasized with a frame line surrounding the tour sound name 85.

The corresponding tour sound 75 may be displayed on the map information 18 of the GUI 52 for region settings as shown in FIG. 16 at the same time as selecting the tour sound name 85.

Moreover, as in the GUI 53 for area sound settings, the tour sound names 85 and the type information icons 63 each showing the layer may be displayed at the same time. Moreover, the respective tour sound names 85 may be grouped.

In order to realize these processes, the tour sound list display unit 78 and the map/region display unit 43 cooperatively acquire various types of information about the tour sound 75.

In addition, display contents and operations for the GUI 79 for tour sound settings are not limited.

Displaying the GUI 79 for tour sound settings enables the creator 5 to easily understand the arranged tour sounds 75 in the current state. Moreover, listing the tour sound names 85 can easily manage the arranged tour sounds 75 and the type information of the respective tour sounds 75. This can produce the sound content map 1 with excellent workability.

Various types of information about the region 3 are displayed on the GUI 54 for advanced settings.

For example, the creator 5 selecting one of the tour sounds 75 on the map information 18 displays the detailed information related to the tour sound 75 on the GUI 54 for advanced settings. Alternatively, selecting one of the tour sound names 85 displayed on the GUI 79 for tour sound settings may display detailed information on the GUI 54 for advanced settings. In order to realize these processes, the tour sound list display unit 78, the map/region display unit 43, and the advanced settings unit 45 cooperatively acquire various types of information about the tour sound 75.

As shown in FIG. 16, a space name setting field 64, a space category setting field 65, a sound file setting field 66, a sequential setting field 67, a number-of-playback times setting field 68, a repeat setting field 69, a fade-in/out setting field 70, and a playback stop condition setting field 71 are displayed on the GUI 54 for advanced settings. Each field has contents similar to those of the first embodiment. Therefore, the descriptions will be omitted.

FIG. 16 shows a state in which the tour (speech) is selected on the GUI 79 for tour sound settings and the GUI 54 for advanced settings. Moreover, FIG. 17 A shows a state in which the tour (BGM) is selected and the GUI 54 for advanced settings. Moreover, FIG. 17 B shows a state in which the tour (ambient sound) is selected and the GUI 54 for advanced settings. In each example, items displayed on the GUI 54 for advanced settings have no difference.

The creator 5 can perform various advanced settings related to the tour sound 75 by operating each item of the GUI 54 for advanced settings.

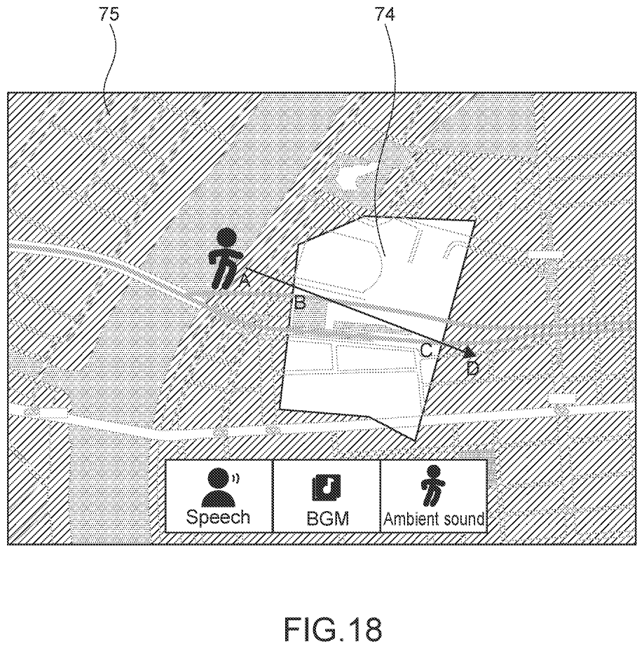

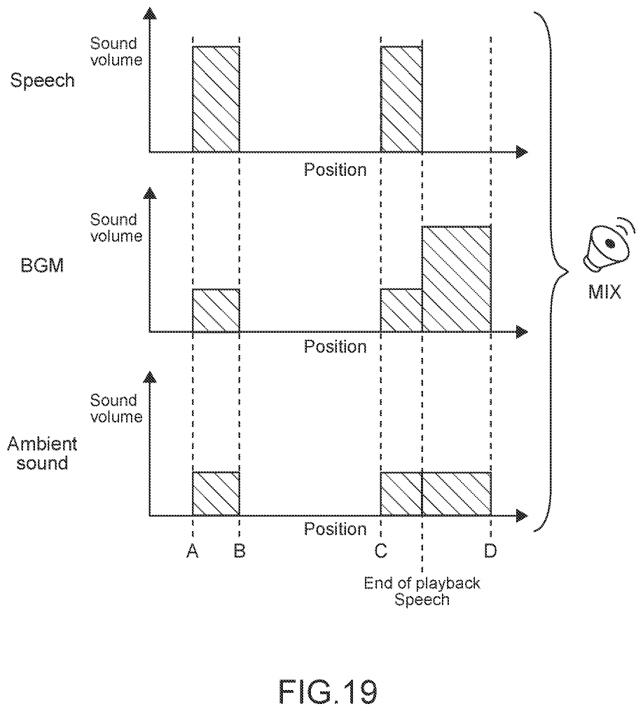

FIGS. 18 and 19 are schematic views showing an example of sound volume control based on the degree of priority.

FIG. 18 shows a movement path of the content user 2.

As shown in FIG. 18, a plurality of tour sounds 75 is arranged on the map information 18. Specifically, three kinds of tour sound 75 in the same shape are arranged in each of the speech layer, the BGM layer, and the ambient sound layer. Thus, the tour sounds 75 are regions overlapping each other.

The three tour sounds 75 are each associated with the sound content data 4. In the present embodiment, the tour sounds 75 in the layers are respectively associated with the speech, the BGM, and the ambient sound.

It should be noted that the area sound 74 is not associated with the sound content data 4 in each layer. In this manner, only the tour sound 75 can be associated with the sound content data 4.

It is assumed that the content user 2 moves along the movement path shown in FIG. 18.

First of all, the application program according to the present technology is started at Point A on the three tour sounds 75.

Next, the content user 2 moves on the three tour sounds 75 and enters the three area sounds 74 at Point B.

Next, the content user 2 moves on the region combining the three area sounds 74 and enters the three tour sounds 75 at Point C again.

At last, the content user 2 moves on the three tour sounds 75 and the application program according to the present technology ends at Point D.

Therefore, the content user 2 sequentially moves in the regions below.

(1) The overlap region of the three tour sounds 75 (between Points A and B)

(2) The region combining the three area sounds 74 (between Points B and C)

(3) The overlap region of the three tour sounds 75 (between Points C and D)

FIG. 19 shows graphs of the sound volume associated with the position of the content user 2.

In the present embodiment, the sound volume control is based on the degree of priority. It should be noted that as in the first embodiment, settings are made so that the speech layer has the highest degree of priority, the BGM layer has the second highest degree of priority, and the ambient sound layer has the third highest degree of priority.

As shown in FIG. 19, the speech with the highest degree of priority is played at a higher sound volume when the content user 2 is located between Points A and B. The BGM and the ambient sound with a lower degree of priority are played at a lower sound volume.

No sounds are played when the content user 2 is located between Points B and C.

The speech is played at the higher sound volume as between Points A and B when the content user 2 enters the three tour sounds 75 from Point C again. Moreover, the BGM and the ambient sound are played at the lower sound volume.

In the example shown in FIG. 19, the playback of the speech ends while the content user 2 moves between Points C and D. For example, repeat playback is not set to the speech, and the playback is terminated when the audio data is played to the end.

In such a case, the playback control unit 11 of the viewer terminal 6 plays the BGM at the higher sound volume in the overlap region in a case where the speech is not being played.

That is, as shown in FIG. 19, the BGM is played at the lower sound volume between Points C and D until the playback of the speech ends. When the playback of the speech ends, the sound volume of the BGM is increased and the BGM is played at the same sound volume as the played speech.

It should be noted that since the ambient sound has the lowest degree of priority, its playback at the lower sound volume is kept.

The BGM and the ambient sound are played at Point D until the application program is stopped.

In a case where the sound content data 4 with the higher degree of priority is being played, the sound volume of the other sound content data 4 is controlled to lower so that the content user 2 can easily hear this sound content data 4.

However, after the playback of the sound content data 4 with the higher degree of priority ends, the sound volume of the other sound content data 4 does not need to be controlled to lower. Here, controlling the sound volume of the other sound content data 4 to lower makes it difficult for the content user 2 to easily hear it.

Therefore, as in the present embodiment, the control to increase the sound volume of the sound content data 4 with the lower degree of priority is made after the playback of the sound content data 4 with the higher degree of priority ends.

This enables the content user 2 to easily hear the sound content data 4. This can provide a high-quality user experience.

It should be noted that as in the first embodiment, the playback contents of the sound content data 4 with the lower degree of priority may be switched in accordance with switching of play/non-play of the sound content data 4 with the higher degree of priority. In addition, the contents of the playback control based on the degree of priority are not limited.

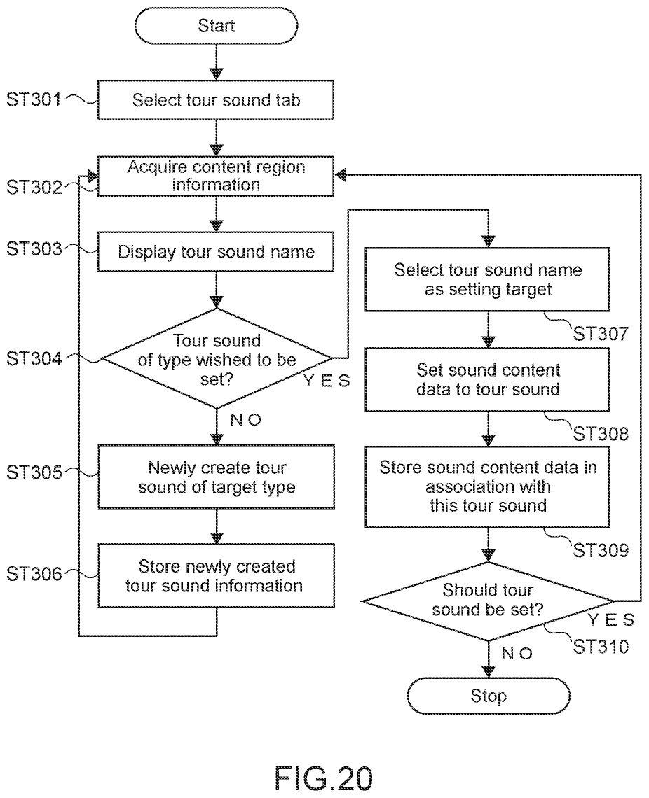

FIG. 20 is a flowchart showing a processing example related to settings of the tour sound 75 and the sound content data 4.

FIG. 20 shows a method of setting the sound content data 4 to the tour sound 75 as an example. Note that similar processing can set the layer, the region names 62, the playback order, and the like.

First of all, the creator 5 selects the tour sound tab 84 on the GUI 82 for area sound/tour sound settings (Step 301).

The tour sound list display unit 78 acquires the layer region information from the storage unit 40 (Step 302). Specifically, all those stored in the storage unit 40 out of the layer region information of the speech layer, the BGM layer, or the ambient sound layer are acquired.

The tour sound names 85 is displayed on the GUI 79 for tour sound settings (Step 303).

The tour sound list display unit 78 acquires the tour sound names 85 associated with the tour sound 75 on the basis of the acquired layer region information. Moreover, the acquired tour sound names 85 are displayed as a list.

In a case where a tour sound 75 of the layer that the creator 5 wishes to set is not displayed (NO in Step 304), the tour sound 75 of the layer is newly created (Step 305).

Specifically, the creator 5 newly creates the tour sound 75 by pressing one of the add buttons 86.

The newly created tour sound 75 is stored (Step 306).

The map/region display unit 43 associates the tour sound 75 with the layer. Then, the storage unit 40 stores them as the layer region information.

When the layer region information is stored, the layer region information is acquired again and processing such as displaying the tour sound names 75 is performed.

In a case where the tour sound 75 of the layer that the creator 5 wishes to set is displayed (YES in Step 304), the creator 5 selects one of the tour sound names 85 as a setting target (Step 307).

The sound content data 4 is set to the selected tour sound 75 (Step 308).

The creator 5 designates the audio file as the sound content data 4 in the sound file setting field 66 on the GUI 54 for advanced settings.

The tour sound 75 is associated with the sound content data 4 and stored (Step 309).

The advanced settings unit 45 associates the designated sound content data 4 with the tour sound 75 and the layer stored in the storage unit 40 and stores them. Accordingly, the content region information is stored.

In a case where there is a tour sound 75 to which the sound content data 4 should be set (YES in Step 310) and the creator 5 designates the sound content data 4, the layer region information is acquired again and processing such as displaying the tour sound names 85 is performed.

In a case where there is no tour sound 75 to which the sound content data 4 should be set (NO in Step 310), the processing ends.

### Other Embodiments

The present technology is not limited to the above-mentioned embodiments, and various other embodiments can be made.

The presence/absence of a playback history in the other area sound 74 may be set as the condition to start the playback of the sound content data 4 associated with the predetermined area sound 74.

For example, sound content data a associated with the region A is played when the content user 2 enters the region A if the content user 2 entered the region B in past and viewed sound content data b associated with the region B. On the other hand, the sound content data a is not played if the content user 2 did not enter the region B and has not yet viewed the sound content data b.

Such settings can determine whether or not to perform playback in the predetermined area sound 74 on the basis of the playback history of the other area sound 74.

For example, a condition that the content user 2 can view the sound content data 4 only after the content user 2 arrives at a predetermined place (area) in a role playing game or the like even if the content user 2 enters the predetermined area sound 74 can be added to the content user 2. As a result, fun content that can provide a more entertaining game can be realized, for example. This can provide a high-quality user experience.

It should be noted that a playback start condition is, for example, set on the GUI 54 for advanced settings.

It may be possible to save (import) and read out (export) the created sound content map 1.

For example, the creator 5 presses a save button (not shown) on the GUI for settings 51. Pressing the save button causes the storage unit of the content providing server 8 to store the created sound content map 1.

Specifically, the communication unit 30 of the content providing server 8 receives various types of information associated with the sound content map 1, which are sent from the communication unit 37 of the information processing apparatus 9, via the network 10. The content input/output unit 33 stores the data received by the communication unit 30 in the storage unit 40.

For example, the map information 18, the content region information, and the like are stored.

Pressing a read-out button or the like may read out the sound content map 1 to the GUI for settings 51.

Moreover, the creator 5 may be able to import the sound content map 1 created by a person different from the creator 5.

In this case, the content providing server 8 is capable of communicating with a plurality of information processing apparatuses 9. For example, the content input/output unit 33 exports a sound content map 1 created by a creator A to the content providing server 8 from an information processing apparatus A owned by the creator A.

Then, an information processing apparatus B owned by a creator B imports the sound content map 1 from the content providing server 8.

For example, this enables a creator 5 who is a beginner and not much skilled in experience of producing sound content maps 1 to refer to sound content maps 1 created by skilled creators 5.

It may be possible to set a playback duration on the GUI 54 for advanced settings.

For example, the advanced settings unit 45 displays a playback duration setting field.

The playback duration is a time from the end of playback of the sound content data 4 to the start of next playback of the sound content data 4.

For example, this can adjust the duration for playing a sound effect and can design the atmosphere or the like of a facility to be realistic.

It may be possible to make settings related to ducking on the GUI 54 for advanced settings.

The ducking is processing of reducing the sound volume of the originally played sound content data 4 when playing other sound content data 4.

That is, the sound volume and the like of the sound content data 4 with the lower degree of priority or the like, for example, when playing the sound content data 4 with the higher degree of priority, are set.

As a matter of course, it may be possible to set the contents other than the sound volume, such as tone and localization.

A beacon may be used for acquiring the position information of the content user 2.

For example, the beacon is placed in a facility or the like. The content user 2 approaching the beacon causes the communication unit 21 of the viewer terminal 6 to acquire a signal emitted from the beacon. Position information (latitude information and longitude information) of the content user 2 is calculated based on the received signal.

For example, arranging the beacon in a facility or area where the GPS accuracy is low can compensate for low accuracy of calculated position information.

Moreover, both position information calculation based on signals from the beacon and position information calculation based on the GPS may be performed near the beacon. As a matter of course, position information calculation based on the GPS may be stopped near the beacon.

This can detect the position information of the content user 2 accurately.

Some or all of the functions of the content providing server 8 shown in FIG. 1 may be mounted on the information processing apparatus 9. Alternatively, some or all of the functions of the viewer terminal 6 may be mounted using a portable information processing apparatus 9. For example, the information processing apparatus 9 may include the playback control unit 11 shown in FIG. 1.

That is, a plurality of computers may realize or a single computer may realize the content providing system 100.

FIG. 21 is a block diagram showing hardware configuration examples of a computer 88 that can realize the viewer terminal 6, the content providing server 8, and the information processing apparatus 9.

The computer 88 includes a CPU 89, a ROM 90, a RAM 91, an input/output interface 92, and a bus 93 for connecting them. A display unit 94, an input unit 95, a storage unit 96, a communication unit 97, and a drive unit 98, and the like are connected to the input/output interface 92.

The display unit 94 is, for example, a display device using liquid crystals, EL or the like. The input unit 95 includes, for example, a keyboard, a pointing device, a touch panel, and other operation devices. In a case where the input unit 95 includes a touch panel, the touch panel can be integrated with the display unit 94.

The storage unit 96 is a nonvolatile storage device and includes, for example, an HDD, a flash memory, and other solid-state memories. The drive unit 98 is a device capable of driving a removable storage medium 99, e.g., an optical storage medium or a magnetic recording tape.

The communication unit 97 includes a modem, a router, and other communication devices for communicating with other devices, which can be connected to a LAN, a WAN, or the like. The communication unit 97 may perform wired or wireless communication. The communication unit 97 is often used separated from the computer 88.

Cooperation of software stored in the storage unit 96, the ROM 90, or the like with hardware resources of the computer 88 realizes information processing by the computer 88 having the above-mentioned hardware configurations. Specifically, loading and executing the program that configures the software, which is stored in the ROM 90 or the like, to the RAM 91 realizes the information processing method according to the present technology.

The program is installed in the computer 88, for example, via the removable storage medium 99. Alternatively, the program may be installed in the computer 88 via a global network or the like. Otherwise, any non-transitory storage medium readable by the computer 88 may be used.

Cooperation of a plurality of computers connected to be capable of communicating with each other via a network or the like may execute the information processing method according to the present technology and may build the information processing system according to the present technology and the information processing apparatus.

That is, not only a computer system constituted by a single computer, but also a computer system where a plurality of computers operates cooperatively can execute the information processing method according to the present technology.

It should be noted that in the present disclosure, the system means a set of a plurality of components (apparatus, module (parts), and the like) and it does not matter whether or not all the components are housed in the same casing. Therefore, both of a plurality of apparatuses housed in separate casings and connected to one another via a network and a single apparatus having a plurality of modules housed in a single casing are the system.

Executing the information processing method according to the present technology by the computer system includes, for example, both of a case where a single computer performs map information acquisition, content region information setting, region superimposition display, and the like and a case where different computers perform these processes. Moreover, executing the respective processes by a predetermined computer includes causing other computers to perform some or all of those processes and acquiring the results.

That is, the information processing method according to the present technology can also be applied to a cloud computing configuration in which a plurality of apparatuses shares and cooperatively processes a single function via a network.

The respective configurations such as the content providing system, the sound content map, the viewer terminal, the content providing server, the information processing apparatus, and the various GUIs, the flow of the processes, and the like, which have been described with reference to the respective drawings, are merely embodiments, and can be arbitrarily modified without departing from the gist of the present technology. That is, any other configurations, algorithms, and the like for carrying out the present technology may be employed.

In the present disclosure, the use of the wording “approximately” is merely for easy understanding of the description and there is no special meanings between the use/non-use of the wording “approximately”.

That is, in the present disclosure, it is assumed that concepts that define shape, size, position relationship, state, and the like, such as “center”, “middle”, “uniform”, “equal”, “the same”, “orthogonal”, “parallel”, “symmetric”, “extending”, “axial”, “columnar”, “cylindrical”, “ring-shaped”, and “annular” are concepts including “substantially center”, “substantially middle”, “substantially uniform”, “substantially equal”, “substantially the same”, “substantially orthogonal”, “substantially parallel”, “substantially symmetric”, “substantially extending”, “substantially axial”, “substantially columnar”, “substantially cylindrical”, “substantially ring-shaped”, “substantially annular”, and the like.

For example, states included in a predetermined range (e.g., ±10% range) using “completely center”, “completely middle”, “completely uniform”, “completely equal”, “completely the same”, “completely orthogonal”, “completely parallel”, “completely symmetric”, “completely extending”, “completely axial”, “completely columnar”, “completely cylindrical”, “completely ring-shaped”, “completely annular”, and the like as the bases are also included.

Therefore, the concept expressed with a so-called “approximately” can be included also when the wording “approximately” is not added. On the contrary, a state expressed with “approximately” does not exclude a complete state.

In the present disclosure, the comparative expressions “something is larger than A” and “something is smaller than A” comprehensively include both a concept including a case where it is equivalent to A and a concept not including a case where it is equivalent to A. For example, “something is larger than A” means not only that it is not equal to A but also that it is “equal to or larger than A”. Moreover, “something is smaller than A” means not only that it is “below A” but also that it is “equal to or smaller than A”.

It is sufficient to employ specific settings or the like as appropriate from the concepts included in “something is larger than A” and “something is smaller than A” so as to provide the effects described above when carrying out the present technology.

At least two features of the features according to the present technology, which have been described above, may be combined. That is, the various features described in the respective embodiments may be arbitrarily combined across the respective embodiments. Moreover, the above-mentioned various effects are merely exemplary and not limitative, and other effects may be provided.

It should be noted that the present technology can also take the following configurations.

(1) An information processing system, including:
an acquisition unit that acquires map information;
a setting unit that associates a region, playback target content, and type information with each other and sets the region, the playback target content, and the type information as content region information, the region being set on the basis of the map information, the type information indicating a playback control type for the playback target content; and
a playback control unit that controls playback of the playback target content on the basis of the type information.

(2) The information processing system according to (1), in which
the playback control unit controls playback of the playback target content on the basis of a position of a viewer with respect to the region.

(3) The information processing system according to (2), in which
the playback control unit controls playback of the playback target content in accordance with entrance or exit of the viewer in/from the region.

(4) The information processing system according to any one of (1) to (3), in which
the type information defines playback control on the playback target content in overlap regions overlapping each other, the playback target content being respectively included in a plurality of pieces of content region information with the regions overlapping each other.

(5) The information processing system according to (4), in which
the type information defines a degree of priority regarding playback control on the playback target content.

(6) The information processing system according to (5), in which
the type information defines a degree of priority regarding at least one of control on a predetermined parameter, play/non-play, or switching of playback contents.

(7) The information processing system according to (6), in which
the playback target content includes at least one of audio data or image data.

(8) The information processing system according to (7), in which
the type information includes first type information and second type information, the second type information having a degree of priority lower than a degree of priority of the first type information, and
the playback control unit, in the overlap regions,
   plays the playback target content associated with the first type information by a first control method, and
   plays the playback target content associated with the second type information by a second control method different from the first control method in a case where the playback target content associated with the first type information is being played or plays the playback target content associated with the second type information by a third control method different from the second control method in a case where the playback target content associated with the first type information is not being played.

(9) The information processing system according to (8), in which
the third control method is a same control method as the first control method.

(10) The information processing system according to any one of (7) to (9), in which
the type information includes first type information and second type information having a degree of priority lower than a degree of priority of the first type information, and
the playback control unit restricts, in the overlap regions, playback of the playback target content associated with the second type information while the playback target content associated with the first type information is being played.

(11) The information processing system according to any one of (7) to (10), in which
the type information includes first type information and second type information having a degree of priority lower than a degree of priority of the first type information, and
the playback control unit switches, in the overlap regions, the playback contents with respect to the playback target content associated with the second type information in accordance with switching of play/non-play of the playback target content associated with the first type information.

(12) The information processing system according to any one of (1) to (11), in which
the setting unit associates the type information with the playback target content in accordance with a type of the playback target content.

(13) The information processing system according to (12), in which
the playback target content is audio data, and
a type of the audio data includes at least one of speech, background music (BGM), or an ambient sound.

(14) The information processing system according to (13), in which
the setting unit associates the speech with the type information with a first degree of priority, associates the BGM with the type information with a second degree of priority different from the first degree of priority, and associates the ambient sound with the type information with a third degree of priority different from each of the first degree of priority and the second degree of priority.

(15) The information processing system according to any one of (1) to (14), in which
The information processing system according to claim 1, wherein
the setting unit associates at least one of a region designated by a user or a region other than the region designated by the user with the playback target content and the type information and sets the content region information.

(16) The information processing system according to (15), further including
an output unit that outputs assistance information related to designation of the region by the user.

(17) The information processing system according to (16), in which
the assistance information includes at least one of image information including the map information, a graphical user interface (GUI), an icon, or an audio guide.

(18) The information processing system according to any one of (1) to (17), further including
a display control unit that superimposes and displays the region on the map information.

(19) An information processing apparatus, including:
an acquisition unit that acquires map information; and
a setting unit that associates a region, playback target content, and type information with each other and sets the region, the playback target content, and the type information as content region information, the region being set on the basis of the map information, the type information indicating a playback control type for the playback target content.

(20) A content playback apparatus that is connected to an information processing system, in which
the information processing system
   sets content region information with a region, playback target content, and type information associated with each other, the region being set on the basis of the map information, the type information indicating a playback control type for the playback target content, and
   controls playback of the playback target content on the basis of the type information, and
the content playback apparatus plays the playback target content in accordance with playback control by the information processing system.

(21) An information processing method, including:
by a computer system,
acquiring map information;
associating a region, playback target content, and type information with each other and setting the region, the playback target content, and the type information as content region information, the region being set on the basis of the map information, the type information indicating a playback control type for the playback target content; and
controlling playback of the playback target content on the basis of the type information.

(22) A program that causes a computer system to execute the steps of:
acquiring map information;
associating a region, playback target content, and type information with each other and setting the region, the playback target content, and the type information as content region information, the region being set on the basis of the map information, the type information indicating a playback control type for the playback target content; and
controlling playback of the playback target content on the basis of the type information.

(23) The information processing system according to any one of (1) to (17), in which
the playback target content includes a plurality of pieces of content data, and
the control unit plays a piece of content data selected at random from the plurality of pieces of content data.

(24) The information processing system according to any one of (1) to (17), in which
the playback target content includes a plurality of pieces of content data, and
the control unit plays the plurality of pieces of content data in a predetermined order.

### REFERENCE SIGNS LIST

100 content providing system
3 region
4 sound content data
5 creator
9 information processing apparatus
11 playback control unit
12 acquisition unit
13 setting unit
14 display control unit
18 map information
27 playback control unit
42 layer selection unit
43 map/region display unit
44 area sound list display unit
45 advanced settings unit
74 area sound
75 tour sound

1. An information processing system, comprising:
an acquisition unit that acquires map information;
a setting unit that associates a region, playback target content, and type information with each other and sets the region, the playback target content, and the type information as content region information, the region being set on a basis of the map information, the type information indicating a playback control type for the playback target content; and
a playback control unit that controls playback of the playback target content on a basis of the type information.

2. The information processing system according to claim 1, wherein
the playback control unit controls playback of the playback target content on a basis of a position of a viewer with respect to the region.

3. The information processing system according to claim 2, wherein
the playback control unit controls playback of the playback target content in accordance with entrance or exit of the viewer in/from the region.

4. The information processing system according to claim 1, wherein
the type information defines playback control on the playback target content in overlap regions overlapping each other, the playback target content being respectively included in a plurality of pieces of content region information with the regions overlapping each other.

5. The information processing system according to claim 4, wherein
the type information defines a degree of priority regarding playback control on the playback target content.

6. The information processing system according to claim 5, wherein
the type information defines a degree of priority regarding at least one of control on a predetermined parameter, play/non-play, or switching of playback contents.

7. The information processing system according to claim 6, wherein
the playback target content includes at least one of audio data or image data.

8. The information processing system according to claim 7, wherein
the type information includes first type information and second type information, the second type information having a degree of priority lower than a degree of priority of the first type information, and
the playback control unit, in the overlap regions,
plays the playback target content associated with the first type information by a first control method, and
plays the playback target content associated with the second type information by a second control method different from the first control method in a case where the playback target content associated with the first type information is being played or plays the playback target content associated with the second type information by a third control method different from the second control method in a case where the playback target content associated with the first type information is not being played.

9. The information processing system according to claim 8, wherein
the third control method is a same control method as the first control method.

10. The information processing system according to claim 7, wherein
the type information includes first type information and second type information having a degree of priority lower than a degree of priority of the first type information, and
the playback control unit restricts, in the overlap regions, playback of the playback target content associated with the second type information while the playback target content associated with the first type information is being played.

11. The information processing system according to claim 7, wherein
the type information includes first type information and second type information having a degree of priority lower than a degree of priority of the first type information, and
the playback control unit switches, in the overlap regions, the playback contents with respect to the playback target content associated with the second type information in accordance with switching of play/non-play of the playback target content associated with the first type information.

12. The information processing system according to claim 1, wherein
the setting unit associates the type information with the playback target content in accordance with a type of the playback target content.

13. The information processing system according to claim 12, wherein
the playback target content is audio data, and
a type of the audio data includes at least one of speech, background music (BGM), or an ambient sound.

14. The information processing system according to claim 13, wherein
the setting unit associates the speech with the type information with a first degree of priority, associates the BGM with the type information with a second degree of priority different from the first degree of priority, and associates the ambient sound with the type information with a third degree of priority different from each of the first degree of priority and the second degree of priority.

15. The information processing system according to claim 1, wherein
the setting unit associates at least one of a region designated by a user or a region other than the region designated by the user with the playback target content and the type information and sets the content region information.

16. The information processing system according to claim 15, further comprising
an output unit that outputs assistance information related to designation of the region by the user.

17. The information processing system according to claim 16, wherein
the assistance information includes at least one of image information including the map information, a graphical user interface (GUI), an icon, or an audio guide.

18. The information processing system according to claim 1, further comprising
a display control unit that superimposes and displays the region on the map information.

19. An information processing apparatus, comprising:
an acquisition unit that acquires map information; and
a setting unit that associates a region, playback target content, and type information with each other and sets the region, the playback target content, and the type information as content region information, the region being set on a basis of the map information, the type information indicating a playback control type for the playback target content.

20. A content playback apparatus that is connected to an information processing system, wherein
the information processing system
sets content region information with a region, playback target content, and type information associated with each other, the region being set on a basis of the map information, the type information indicating a playback control type for the playback target content, and
controls playback of the playback target content on a basis of the type information, and
the content playback apparatus plays the playback target content in accordance with playback control by the information processing system.
